(19) United States
(12) Patent Application Publication
(10) Pub. No.: US 2026/0212421 A1
(43) Pub. Date: Jul. 23, 2026

(54) MANAGEMENT OF RESOURCE EXCHANGE FOR COLLATERALIZED MEDICAL CLAIMS

(71) Applicant: Reclaimz Inc., Alpharetta, GA (US)

(72) Inventors: Anand Krishnan, Princeton, NJ (US); Seshadri Madapoosi, Alpharetta, GA (US)

(21) Appl. No.: 19/026,832

(22) Filed: Jan. 17, 2025

(51) Int. Cl. G06Q 40/08; G06Q 40/03

(52) U.S. Cl. CPC G06Q 40/08; G06Q 40/033; G06Q 40/034; G06Q 40/09

(57) ABSTRACT

The present disclosure relates to a system and a method for management of resource exchange for collateralized medical claims. The method includes retrieving a resource exchange entry corresponding to exchange of resources for collateralized medical claims associated with a medical facility. The method further includes retrieving a set of input parameters from each medical claim and determining a risk score and a collateral value for each medical claim. Furthermore, the method includes determining when the risk score of a first medical claim from the collateralized medical claims exceeds a risk score threshold value and in response removing the first medical claim. Furthermore, the method includes updating a net collateral value of the collateralized medical claims.

### TECHNICAL FIELD

The embodiments of the present disclosure generally relate to the field of healthcare system management. More particularly, the present disclosure relates to management of resource exchange for collateralized medical claims.

### BACKGROUND OF THE INVENTION

The subject matter disclosed in the background section should not be assumed or construed to be prior art merely due to its mention in the background section. Similarly, any problem statement mentioned in the background section or its association with the subject matter of the background section should not be assumed or construed to have been previously recognized in the prior art.

In recent years, healthcare sector has been under tremendous financial pressure due to the increase of costs accompanied by the unpredictable cash flow. Majority of revenue of medical facilities come from reimbursements of medical claims submitted by the payers, which in turn can take days or even months to process, further adding to the unpredictability of the cash flow.

Processing the medical claims usually takes a significant time, which results in a temporary financial deficit for the medical facilities. To keep the healthcare facilities running, maintaining medical apparatuses, and paying salaries to the staff, the medical facilities usually seek monitory benefits from financial partners in terms of loans. However, the interest rates of unprotected loans are very high, which acts as a long-term burden for the medical facilities.

To avoid high interest rates of the loans, the medical facilities can submit their assets as collateral for the loan, which in some way adds an assurance for the loan to be paid off by the medical facility. However, the medical facilities do not have any significant assets apart from their infrastructure and tools (e.g., surgical apparatus, diagnosis machines, etc.) which they can collateralize for receiving loan from the financial partners. Moreover, a monitory value of the assets that can be used as collaterals can also vary (i.e., usually depreciates with time), which causes instability of the trade and results in an uncertainty for the financial partners to trade assets of the medical facility (as collateral) in exchange of their money (as loan).

Contemporary solutions fail to address the challenges associated with exchange of resources between the medical facility and the financial partners. Moreover, the contemporary solutions lack transparency of resource exchange in terms of a dynamic risk associated with the transaction as well as a dynamic collateral value of the assets. In view of the challenges, there is a need of a technical solution that can overcome the existing problems for resource exchange between the medical facility and the financial partners and can provide a transparent and unbiased solution for a confident resource exchange between the medical facilities and the financial partners.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

According to an embodiment, a method for managing resources associated with a secondary client (e.g., a finance provider) is provided. The method includes retrieving a resource exchange entry corresponding to exchange of the resources for one or more collateralized medical claims associated with a medical facility from a database. The method further includes retrieving a set of input parameters from each medical claim of the one or more collateralized medical claims. The set of input parameters for each medical claim comprises a claim age value of the medical claim and a days to pay (DTP) value for the medical claim. Furthermore, the method includes determining a risk score and a collateral value for each medical claim of the one or more collateralized medical claims through a first Machine Learning (ML) model trained using historical claim data. The risk score and the collateral value dynamically change based on a variation in the claim age value of the medical claim, the DTP value for the medical claim, a new claim settlement entry in the historical claim data, or a combination thereof. Furthermore, the method includes determining a net collateral value of the one or more medical claims by summing the collateral value of each medical claim. Furthermore, the method includes determining whether the risk score of a first medical claim of the one or more collateralized medical claims exceeds a risk score threshold value. Furthermore, the method includes removing the first medical claim from the one or more medical claims in response to the determination that the risk score of the first medical claim exceeds the risk score threshold value. Moreover, the method includes updating the net collateral value of the one or more collateralized medical claims based on the removal of the first medical claim from the one or more collateralized medical claims.

In some aspects of the present disclosure, the set of input parameters comprises a claim identifier, a claim amount, and a claim date for the medical claim. The historical claim data comprises information of a plurality of medical claim settlements. The claim age value corresponds to a duration between a present temporal value and the claim date, and the DTP value corresponds to a duration between the present temporal value and an expected claim settlement date.

In some aspects of the present disclosure, the method further includes determining whether the collateral value for a second medical claim from the one or more collateralized medical claims is received by the medical facility from a primary client. Furthermore, the method includes removing the second medical claim from the one or more medical claims in response to the determination that the collateral value for the second medical claim is received by the medical facility from the primary client. Furthermore, the method includes updating the net collateral value of the one or more collateralized medical claims based on the removal of the second medical claim from the one or more collateralized medical claims.

In some aspects of the present disclosure, the method further includes determining, whether a difference between the net collateral value and a collateral exchange value is less than a difference threshold value. The collateral exchange value is determined at a time instance corresponding to a generation of the resource exchange entry and is lower than the net collateral value by a margin exposure value at the time instance. Furthermore, the method includes determining at least one new medical claim from a plurality of collateralized medical claims associated with the medical facility using a second ML model, in response to the determination that the difference between the net collateral value and the collateral exchange value is less than the difference threshold value. Furthermore, the method includes updating the resource exchange entry by adding the at least one new medical claim to the one or more collateralized medical claims. The at least one new medical claim compensates for a change in the net collateral value due to removal of at least one of the first medical claim and the second medical claim.

In some aspects of the present disclosure, the method further includes generating a resource exchange update request for the secondary client using the updated resource exchange entry. Furthermore, the method includes determining whether a resource exchange acknowledgement is received from the secondary client in response to the resource exchange update request. Furthermore, the method includes storing, in response to a determination that the resource exchange acknowledgement is received from the secondary client, the updated resource exchange entry into the database.

In some aspects of the present disclosure, the method further includes determining a risk category from a plurality of risk categories for each medical claim of the one or more collateralized medical claims based on the risk score associated with the medical claim.

According to another embodiment, a system to manage resources associated with a secondary client is presented. The system includes a database and a data processing circuitry communicatively coupled to the database. The data processing circuitry is configured to retrieve a resource exchange entry corresponding to exchange of the resources for one or more collateralized medical claims associated with a medical facility from the database. The data processing circuitry is further configured to retrieve a set of input parameters from each medical claim of the one or more collateralized medical claims. The set of input parameters for each medical claim comprises a claim age value of the medical claim and a days to pay (DTP) value for the medical claim. Furthermore, the data processing circuitry is configured to determine, through a first Machine Learning (ML) model trained using a historical claim data, a risk score and a collateral value for each medical claim of the one or more collateralized medical claims. The risk score and the collateral value dynamically change based on at least one of a variation in the claim age value of the medical claim, the DTP value for the medical claim, and a new claim settlement entry in the historical claim settlement data. Furthermore, the data processing circuitry is configured to determine a net collateral value of the one or more medical claims by summing the collateral value of each medical claim. Furthermore, the data processing circuitry is configured to determine whether the risk score of a first medical claim of the one or more collateralized medical claims exceeds a risk score threshold value. Furthermore, the data processing circuitry is configured to remove the first medical claim from the one or more medical claims in response to the determination that the risk score of the first medical claim exceeds the risk score threshold value. Moreover, the data processing circuitry is configured to update the net collateral value of the one or more collateralized medical claims based on the removal of the first medical claim from the one or more collateralized medical claims.

According to yet another embodiment, a computer-program product for managing resources associated with a secondary client is presented. The computer program product comprises computer-executable instructions that are stored on a non-transitory computer-readable medium and that, when executed by data processing circuitry performs multiple operations. The operations include retrieving a resource exchange entry corresponding to exchange of the resources for one or more collateralized medical claims associated with a medical facility from a database. The operations further include retrieving a set of input parameters from each medical claim of the one or more collateralized medical claims. The set of input parameters for each medical claim comprises a claim age value of the medical claim and a days to pay (DTP) value for the medical claim. Furthermore, the operations include determining a risk score and a collateral value for each medical claim of the one or more collateralized medical claims through a first Machine Learning (ML) model trained using historical claim data. The risk score and the collateral value dynamically change based on a variation in the claim age value of the medical claim, the DTP value for the medical claim, a new claim settlement entry in the historical claim data, or a combination thereof. Furthermore, the operations include determining a net collateral value of the one or more medical claims by summing the collateral value of each medical claim. Furthermore, the operations include determining whether the risk score of a first medical claim of the one or more collateralized medical claims exceeds a risk score threshold value. Furthermore, the operations include removing the first medical claim from the one or more medical claims in response to the determination that the risk score of the first medical claim exceeds the risk score threshold value. Moreover, the operations include updating the net collateral value of the one or more collateralized medical claims based on the removal of the first medical claim from the one or more collateralized medical claims.

### BRIEF DESCRIPTION OF DRAWINGS

Various embodiments disclosed herein will become better understood from the following detailed description when read with the accompanying drawings. The accompanying drawings constitute a part of the present disclosure and illustrate certain non-limiting embodiments of inventive concepts. Further, components and elements shown in the drawings are not necessarily to scale, emphasis instead being placed upon clearly illustrating the principles of the present disclosure. For the purpose of consistency and ease of understanding, similar components and elements are annotated by reference numerals in the exemplary drawings. In the drawings:

FIG. 1 presents a block diagram of a system to manage resource exchange for collateralized claims, in accordance with an exemplary aspect of the present disclosure;

FIG. 2 illustrates a block diagram depicting a data processing server, in accordance with an exemplary embodiment of the present disclosure;

FIG. 3 presents a block diagram depicting a Machine Learning (ML) model used to collateralize the medical claims, in accordance with an exemplary embodiment of the present disclosure;

FIG. 4 presents a block diagram of a user device, in accordance with an embodiment of the present disclosure;

FIGS. 5(A)-5(C) illustrate Graphical User interfaces (GUIs) presented through the user device corresponding to generation of claim portfolio corresponding to selected medical claims, in accordance with an exemplary aspect of the present disclosure;

FIGS. 6(A)-6(E) illustrate GUIs presented through the user device corresponding to resource exchange, in accordance with an exemplary aspect of the present disclosure;

FIGS. 7(A)-7(D) illustrate GUIs presented through the user device corresponding to management of the resource exchange, in accordance with an exemplary aspect of the present disclosure;

FIGS. 8(A)-8(I) illustrate GUIs presented through the user device corresponding to onboarding and managing accounts of different entities of the system, in accordance with an exemplary aspect of the present disclosure; and

FIG. 9 is a flow chart that depicts a method for managing resource exchange for the collateralized claims, in accordance with an exemplary aspect of the present disclosure.

### DETAILED DESCRIPTION OF THE INVENTION

Inventive concepts of the present disclosure will now be described more fully hereinafter with reference to the accompanying drawings, in which examples of one or more embodiments of inventive concepts are shown. Inventive concepts may, however, be embodied in different forms and should not be construed as limited to the embodiments set forth herein. Further, the one or more embodiments disclosed herein are provided to describe the inventive concept thoroughly and completely, and to fully convey the scope of each of the present inventive concepts to those skilled in the art. Furthermore, it should be noted that the embodiments disclosed herein are not mutually exclusive concepts. Accordingly, one or more components from one embodiment may be tacitly assumed to be present or used in any other embodiment.

The following description presents various embodiments of the present disclosure. The embodiments disclosed herein are presented as teaching examples and are not to be construed as limiting the scope of the present disclosure. The present disclosure should in no way be limited to the illustrative implementations, drawings, and techniques illustrated below, including the exemplary design and implementation illustrated and described herein, but may be modified, omitted, or expanded upon without departing from the scope of the present disclosure.

The following description contains specific information pertaining to embodiments in the present disclosure. The detailed description uses the phrases “in some embodiments” which may each refer to one or more or all of the same or different embodiments. The term “some” as used herein is defined as “one, or more than one, or all.” Accordingly, the terms “one,” “more than one,” “more than one, but not all” or “all” would all fall under the definition of “some.” In view of the same, the terms, for example, “in an embodiment” refers to one embodiment and the term, for example, “in one or more embodiments” refers to “at least one embodiment, or more than one embodiment, or all embodiments.”

The term “comprising,” when utilized, means “including, but not necessarily limited to;” it specifically indicates open-ended inclusion in the so-described one or more listed features, elements in a combination, unless otherwise stated with limiting language. Furthermore, to the extent that the terms “includes,” “has,” “have,” “contains,” and other similar words are used in either the detailed description, such terms are intended to be inclusive in a manner similar to the term “comprising.”

In the following description, for the purpose of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features.

The description provided herein discloses exemplary embodiments only and is not intended to limit the scope, applicability, or configuration of the present disclosure. Rather, the foregoing description of the exemplary embodiments will provide those skilled in the art with an enabling description for implementing any of the exemplary embodiments. Specific details are given in the following description to provide a thorough understanding of the embodiments. However, it may be understood by one of the ordinary skilled in the art that the embodiments disclosed herein may be practiced without these specific details.

The terminology used herein is for the purpose of describing particular embodiments only and is not intended to be limiting of the disclosure. As used herein the description, the singular forms "a", "an", and "the" include plural forms unless the context of the invention indicates otherwise.

The terminology and structure employed herein are for describing, teaching, and illuminating some embodiments and their specific features and elements and do not limit, restrict, or reduce the scope of the present disclosure. Accordingly, unless otherwise defined, all terms, and especially any technical and/or scientific terms, used herein may be taken to have the same meaning as commonly understood by one having ordinary skill in the art.

The present disclosure relates to a system and a method for managing resource exchange between a medical facility and a secondary client (i.e., a finance provider). Particularly the system by way of the method enables management of exchange of collateralized claims associated with the medical facility for monitory loans from the secondary client. In some aspects of the present disclosure, the resources are mapped to various parameters calculated by the system corresponding to a risk associated with the resource exchange. The risk is calculated using Machine Learning (ML) models adaptively trained on historical claim data comprising information related to medical claim settlements. The calculated risk and associated parametric values are dynamic and vary with time and/or new claim settlement entries added to the historical claim data. In some aspects of the present disclosure, the new claim settlement entry in the historical claim data corresponds to a change in at least one of a ranking of the primary client, a rating of the primary client, and a status of the primary client.

Some aspects of the present disclosure present determination of a dynamic collateral value for the collateralized claims for resource exchange. Some other aspects of the present disclosure refer to determination of a risk associated with each collateralized claim in the resource exchange. Yet other aspects of the present disclosure refer to determination of a high-risk scenario for the resource exchange, and in response an option to amend the collateralized claim(s) for the resource exchange.

Some embodiments of the present disclosure relate to use of Machine Learning (ML) models to determine a dynamic risk score and a dynamic collateral value associated with a medical claim. The ML models are trained using historical claim settlement data as well as various details of a payer of the medical claim, based on which the ML models are trained to determine a dynamic risk score as well as a monitory value for the medical claim as collateral. The ML models are further utilized to determine an amount that can be requested as a loan from a financial partner, when the medical claim is submitted as collateral. Moreover, the ML models are trained to generate a dynamic dashboard for a user of the system based on a set of inputs received from the user.

Some embodiments of the present disclosure relate to providing risk profile(s) of the collaterals along with analysis & trends behind this data to a secondary client based on which the secondary client can decide whether the medical claim can be collateralized or not. In some aspects of the present disclosure, the secondary client may further be enabled to track the collaterals through a life cycle of the medical claims and make informed decision.

Some other embodiments of the present disclosure relate to designing a set of protocols for the exchange of monitory resources (such as a loan from a bank) in lieu of the medical claims as collaterals. In simpler words, the set of protocols relate to generating and managing claims portfolio in terms of a monitory value as well as a risk associated with using these medical claims as collaterals. Some embodiments of the present disclosure support access to alternate capital raised through “asset backed lending program” for collateralized claims funding facility.

The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

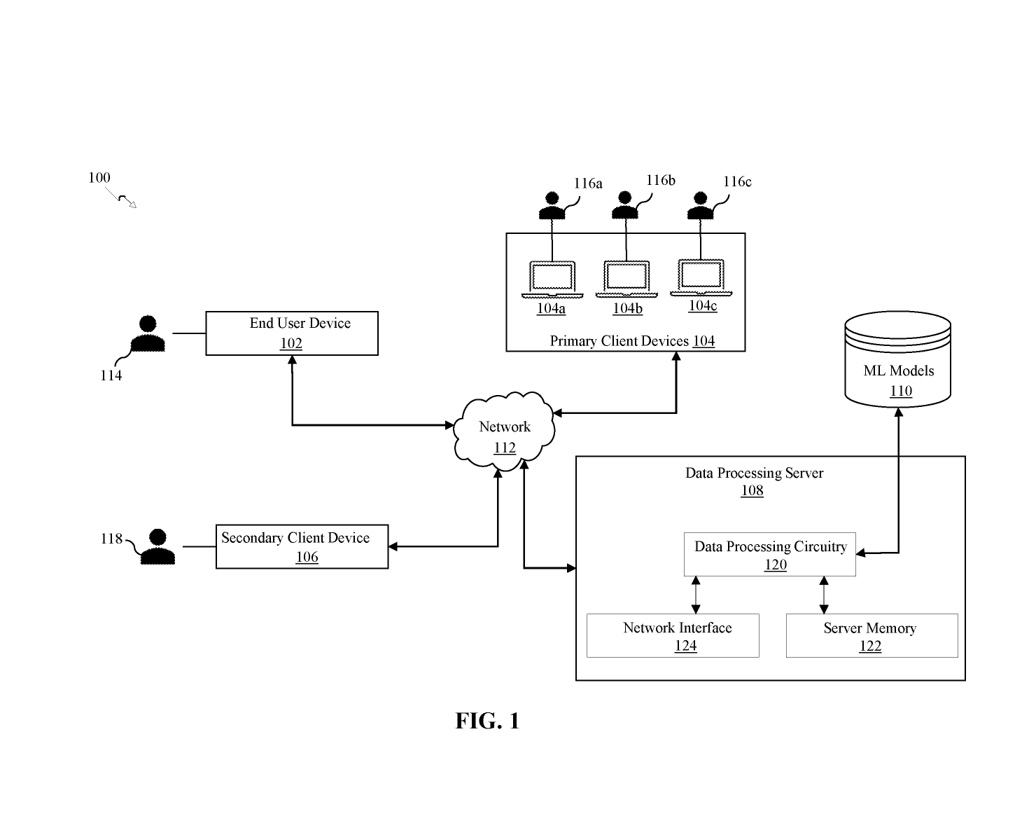

Embodiments of the present disclosure will be described below in detail with reference to the accompanying drawings. FIG. 1 through FIG. 9, discussed below, and the embodiments used to describe the principles of the present disclosure are by way of illustration only and should not be construed in any way to limit the scope of the present disclosure. Those skilled in the art will understand that the principles of the present disclosure may be implemented in any suitably arranged system or device.

Various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

FIG. 1 presents a block diagram of a system 100 to manage resources associated with a secondary client 118 in exchange of collateralized medical claims associated with a medical facility, in accordance with an exemplary aspect of the present disclosure. The system 100 may include an end user device 102, primary client device(s) 104, a secondary client device 106, and a data processing server 108 supported by ML model(s) 110. Various entities of the system 100 may be communicatively coupled to each other by a network 112. The end user device 102 may be associated with the medical facility rendering medical services to patient(s) and may be operated by an end user 114 (e.g., hospital staff operating the end user device 102 on behalf of the medical facility). Each primary client device 104 may be operated by a primary client 116. For illustration, FIG. 1 presents first through third primary client devices 104a-104c operated by first through third clients 116a-116c, respectively. Specifically, the primary clients 116 may be financial payers, that are registered with the system 100 and may be capable of providing their resources (monetarily) in exchange of medical claim(s) as collateral. The secondary client device 106 may be operated by the secondary client 118. Specifically, the secondary client 118 may be a financial partner (such as a bank) registered with the system 100 that may provide monitory resources (i.e., by way of a loan) to the medical facility in exchange of the collateralized medical claim(s).

In some aspects of the present disclosure, the end user device 102 may enable the end user 114 to provide input(s) for collateralization of medical claim(s) rendered by the medical facility. The end user device 102 may enable the end user 114 to provide multiple selection inputs corresponding to a request to collateralize the medical claim(s). Specifically, the selection inputs may correspond to a selection of the medical claim(s) to be collateralize, a selection of preferred primary client(s) 116, a request for exchange of collateralized medical claim with resources of the secondary client 118, and the like. In some other aspects of the present disclosure, the end user device 102 may further facilitate the end user 114 to view a claim portfolio for the collateralized medical claim. Specifically, the claim portfolio may be generated by the data processing server 108 based on transaction(s) between the end user 114 and the clients (cumulatively referring to the primary clients 116 and the secondary client 118).

In some aspects of the present disclosure, the primary client device 104 may enable a corresponding primary client 116 to receive request(s) from the end user device 102. The request(s) may correspond to collateralizing medical claim(s) for medical service(s) rendered by the medical facility. The primary client device 104 may further enable the primary client 116 to provide selection input(s) to accept or reject request(s) from the end user device 102. Furthermore, based on the selection input(s) by the primary client 116, the data processing server 108 may be configured to collateralize the medical claim(s) or discard the request to collateralize the medical claim(s). Moreover, when the medical claim(s) are collateralized, the data processing server 108 may generate dashboard entries corresponding to each medical claim. The primary client device 104 may further enable the primary client 116 to provide display selection input(s), based on which a dashboard may be rendered (e.g., displayed or presented) to the primary client 116 through the primary client device 104. The dashboard facilitates the primary client 116 to manage collateralized transactions with the medical facility.

The presented embodiment shows three primary client devices 104 (i.e., the first through third primary client devices 104a-104c, operated by the first through third primary clients 116a-116c, respectively), however the scope of the present disclosure is not limited to it. In other embodiments, the primary client devices 104 may have any number of primary client devices, without deviating from the scope of the present disclosure. All the primary client devices 104 may be structurally and functionally similar to the first through third primary client devices 104a-104c, as presented herein.

In some aspects of the present disclosure, the secondary client device 106 may enable the secondary client 118 to receive resource exchange request(s) from the end user device 102. The resource exchange request(s) may enable the secondary client 118 to be informed of the collateralized medical claim(s) extended by the end user 114 in exchange of monitory resources (e.g., a loan) from the secondary client 118. The secondary client device 106 may further enable the secondary client 118 to accept or reject the resource exchange request(s) from the end user device 102. Moreover, when the secondary client 118 accepts the resource exchange request(s), the data processing server 108 may generate resource exchange entries corresponding to the resource exchange between the medical facility and the secondary client 118. The secondary client device 106 may further facilitate the secondary client 118 to provide selection input(s) to select data fields corresponding to instances of the resource exchange(s) between the secondary client 118 and the medical facility. Based on the selection input(s), the secondary client device 106 may further render information of resource exchange to the secondary client 118.

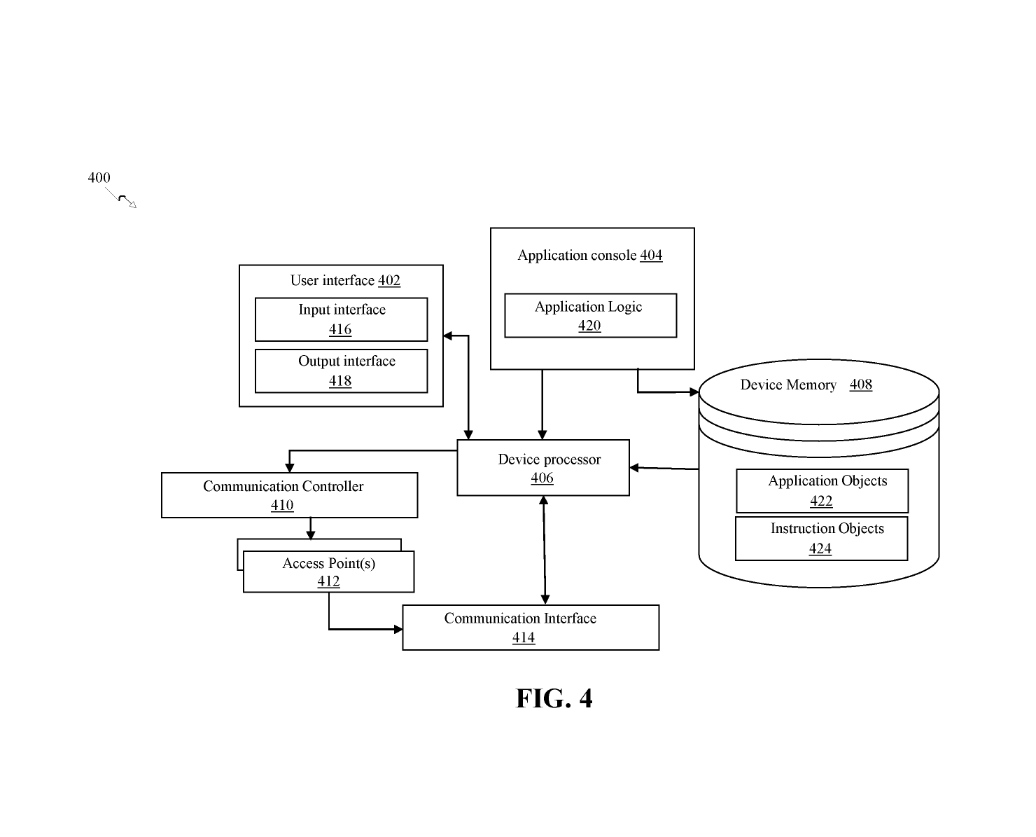

The end user device 102, the primary client device(s) 104, and the secondary client device 106 (presented later in FIG. 4 as ‘user device 400’ and cumulatively referred to as ‘user devices’) may be capable of communicating with the data processing server 108 through the network 112. Each of the user devices may have an electronic application installed, that enables them to interact with the data processing server 108. The electronic application may be hosted by the data processing server 108 such that an application interface of the electronic application may enable the users to provide input(s) and receive output(s) corresponding to collateralization of medical claim(s) and managing resource exchange between the medical facility and the clients (hereinafter referring cumulatively to the primary clients 116 and the secondary client 118). Examples of the user devices may include, but are not limited to portable handheld electronic devices such as a mobile phone, a tablet, a laptop, a smart watch etc., or fixed electronic devices such as a desktop computer, computing devices, etc. Aspects of the present disclosure are intended to include or otherwise cover any type of user device as the user device 400, without deviating from the scope of the present disclosure.

The data processing server 108 may be configured to perform data processing and/or data storage operations to collateralize medical claim(s) and manage resource exchange between the medical facility and the clients. More particularly, the data processing server 108 may be configured to create dashboard entries corresponding to acknowledged request(s) for collateralization of the medical claim(s). The data processing server 108 may further be configured to create resource exchange entries corresponding to acknowledged request(s) for resource exchange between the medical facility and the clients. Furthermore, the data processing server 108 may be configured to create dashboard entries for onboarding of client(s) to use the system 100. Furthermore, the data processing server 108 may be configured to manage the resource exchange(s) between the medical facility and the client(s). In some aspects of the present disclosure, based on the selection input(s), the data processing server 108 may be configured to generate dashboard(s) to be presented to the users (hereinafter cumulatively referring to the end user 114, the primary client 116, and the secondary client 118).

The data processing server 108 may be a network of computers, a software framework, or a combination thereof, that may provide a generalized approach to create a server implementation. Examples of the data processing server 108 may include, but are not limited to, personal computers, laptops, mini-computers, mainframe computers, any non-transient and tangible machine that can execute a machine-readable code, cloud-based servers, distributed server networks, or a network of computer systems. The data processing server 108 may be realized through various web-based technologies such as, but not limited to, a Java web-framework, a .NET framework, a personal home page (PHP) framework, or any web-application framework. In various aspects of the present disclosure, the data processing server 108 may be configured to perform data processing and/or storage operations to enable collateralization of the medical claims.

The data processing server 108 may include data processing circuitry 120 and a server memory 122. The data processing circuitry 120 may include processor(s) configured with suitable logic, instructions, circuitry, interfaces, and/or codes for executing operations of various operations performed by the data processing server 108 for computations and data processing related to collateralization of the medical claims and management of resource exchange between the medical facility and the clients. Examples of the data processing circuitry 120 may include, but are not limited to, an Application Specific Integrated Chip (ASIC) processor, a RISC processor, a CISC processor, a Field Programmable Gate Array (FPGA), and the like.

The server memory 122 may be configured to store logic, instructions, circuitry, interfaces, and/or codes of the data processing circuitry 120 for executing various operations of the system 100. Aspects of the present disclosure are intended to include and/or otherwise cover any type of the data associated with the data processing server 108, without deviating from the scope of the present disclosure. Examples of the server memory 122 may include but are not limited to, a ROM, a RAM, a flash memory, a removable storage drive, a HDD, a solid-state memory, a magnetic storage drive, a PROM, an EPROM, and/or an EEPROM.

The data processing server 108 may further include a network interface 124. The network interface 124 may be configured to enable the data processing server 108 to communicate with various other entities of the system 100 via the network 112. Examples of the network interface 124 may include, but are not limited to, a MODEM, a network interface such as an Ethernet card, a communication port, and/or a Personal Computer Memory Card International Association (PCMCIA) slot and card, an antenna, a radio frequency (RF) transceiver, amplifier(s), a tuner, oscillator(s), a digital signal processor, a coder-decoder (CODEC) chipset, a Subscriber Identity Module (SIM) card, and a local buffer circuit. It will be apparent to a person of ordinary skill in the art that the network interface 124 may include any device and/or apparatus capable of providing wireless or wired communications between the data processing apparatus 108 and various other entities of the system 100.

The data processing server 108 may be supported by ML models 110 to perform data processing task(s) associated with the operations of the system 100. The ML models 110 may be trained to determine a dynamic risk value and an associated dynamic collateral value for a medical claim (i.e., a monitory equivalent value for the medical claim collateralized as asset). The ML models 110 may further be configured to determine medical claim(s) from a number of medical claims associated with the medical facility to be collateralized for resource exchange with the clients based on selection inputs from the clients (such as a net collateral value, a collateral exchange value, and the like). Furthermore, the ML models 110 may be trained to generate dashboard entries for the clients reflecting resource exchange transaction(s) between the clients based on a user selection. In some aspects of the present disclosure, the ML models 110 may be hosted by external datacenter(s). The external datacenter(s) may include suitable logic, circuitry, and/or code(s) to store data and perform computational tasks to support the data processing server 108. Examples of the external data center(s) may include, but are not limited to Oracle Database, Amazon Web Services (AWS) Database, and the like.

The network 112 may include suitable logic, circuitry, and interfaces that may be configured to provide several network ports and several communication channels for transmission and reception of data related to operations of various entities of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The network 112 may be associated with an application layer for implementation of communication protocols based on communication requests from the various entities of the system 100. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof. In some aspects of the present disclosure, the communication data may be transmitted or received via at least one communication channel of several communication channels in the network 112. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, an optical fiber network, a coaxial cable network, an infrared (IR) network, a radio frequency (RF) network, and a combination thereof. Aspects of the present disclosure are intended to include or otherwise cover any type of communication channel, including known, related art, and/or later developed technologies.

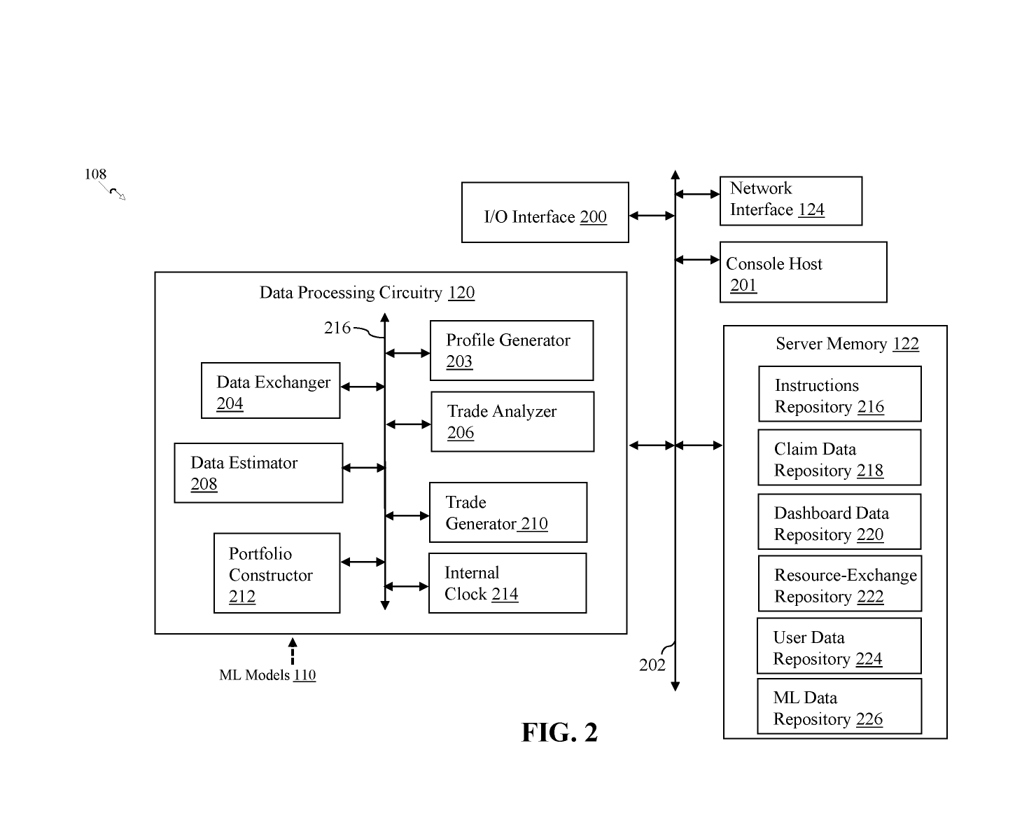

FIG. 2 illustrates a block diagram depicting the data processing server 108, in accordance with an exemplary embodiment of the present disclosure. The data processing server 108 may be configured to perform data processing task(s) and data storage task(s) for collateralization of medical claims and management of resource exchange between the medical facility and the clients. Particularly, the data processing server 108 may be configured to manage resources associated with the secondary client 118 in exchange of collateralized claims from the medical facility. According to the exemplary embodiment as presented through FIG. 2, the data processing server 108 may include the data processing circuitry 120, the server memory 122, the network interface 124, an input-output (I/O) interface 200, and a console host 201 coupled to each other by way of a first communication bus 202.

The I/O interface 200 may include suitable logic, circuitry, interfaces, and/or codes that may be configured to receive input(s) and render output(s) by or from the data processing server 108, respectively. The input(s) may correspond to operation(s) and configuration(s) of various components of the data processing server 108. The output(s) may correspond to an operational status of various components of the data processing server 108.

The console host 201 may include suitable logic, circuitry, interfaces, and/or codes that may be configured for executing various operations of the electronic application on the user devices (cumulatively referring to the end user device 102, the primary client devices 104, and the secondary client device 108), by way of which the users can trigger the data processing server 108 to collateralize the medical claims and/or manage resource exchange for collateralized medical claim(s). In some other aspects of the present disclosure, the console host 201 may further generate Graphical User Interfaces (GUIs) for user interaction.

In the exemplary embodiment as presented through FIG. 2, the data processing circuitry 120 may include a profile generator 203, a data exchanger 204, a trade analyzer 206, a data estimator 208, a trade generator 210, a portfolio constructor 212, and an internal clock 214. Various components of the data processing circuitry 120 may be communicatively coupled to each other by way of a second communication bus 216.

The profile generator 203 may be configured to receive user registration data from the user devices (cumulatively referring to the end user device 102, the primary client devices 104, and the secondary client device 106). The user registration data may include personal identifier containing identity information of the user of the user device. In some aspects of the present disclosure, the user registration data may also include biometric data of the user such as, but not limited to, fingerprints, iris scans, images, voice samples, and the like associated with the user. Aspects of the present disclosure are intended to include or otherwise cover any type of biometric data of the plurality of users without deviating from the spirit and scope of the present disclosure.

The profile generator 203 may further be configured to authenticate the user registration data. In some aspects of the present disclosure, the profile generator 203 may be configured to fetch an identity data of the user from external sources. Furthermore, the profile generator 203 may fetch identity information from the identity data and may compare the identity information fetched from the user registration data with the identity information derived from the identity data. In a scenario, when both the information data match with each other, the profile generator 203 may authenticate the identity of the user and may proceed to generate a user profile for the user based on the identity information derived from the user registration data. In some aspects of the present disclosure, the profile generator 203 may enable the user to set the password protection for logging-in to the system 100. In such a scenario, the profile generator 203 may be configured to verify a password entered by the user for logging-in to the system 100 by comparing the password entered by the user with the set password protection. In a scenario, when the password entered by the user is verified, the profile generator 203 may enable the user to log-in to the system 100. In a scenario, when the password entered by the user is not verified, the profile generator 203 may generate a login error signal to enable a login error to be displayed on the user device.

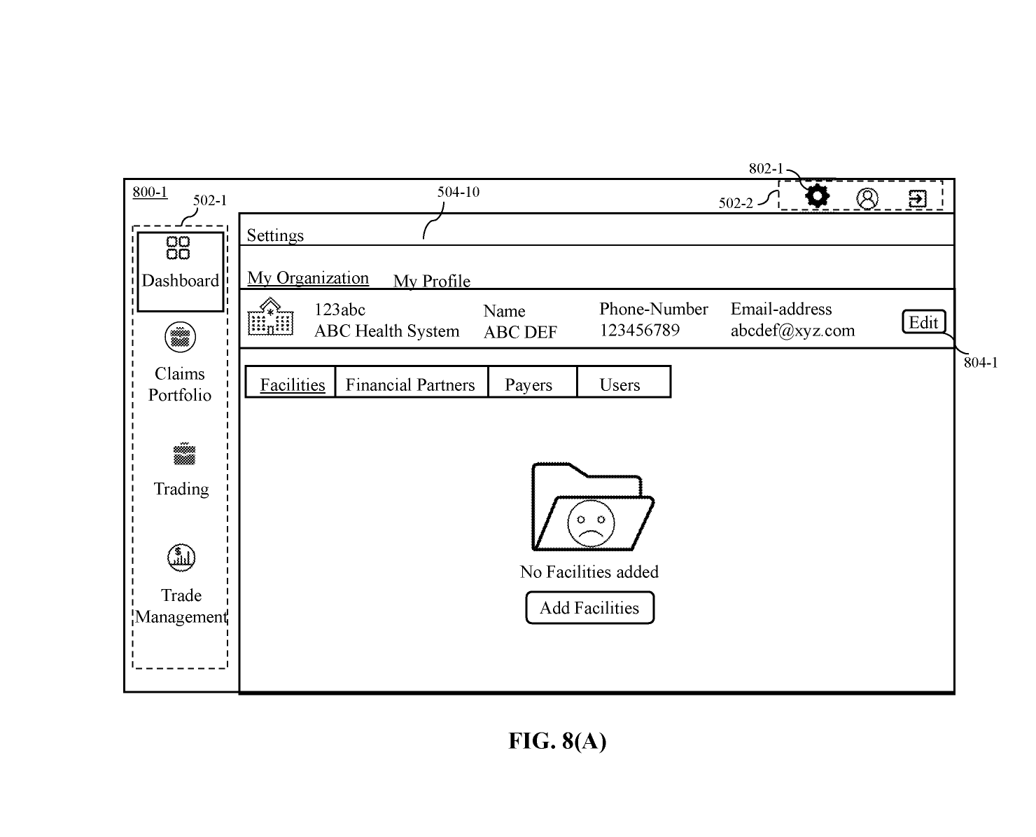

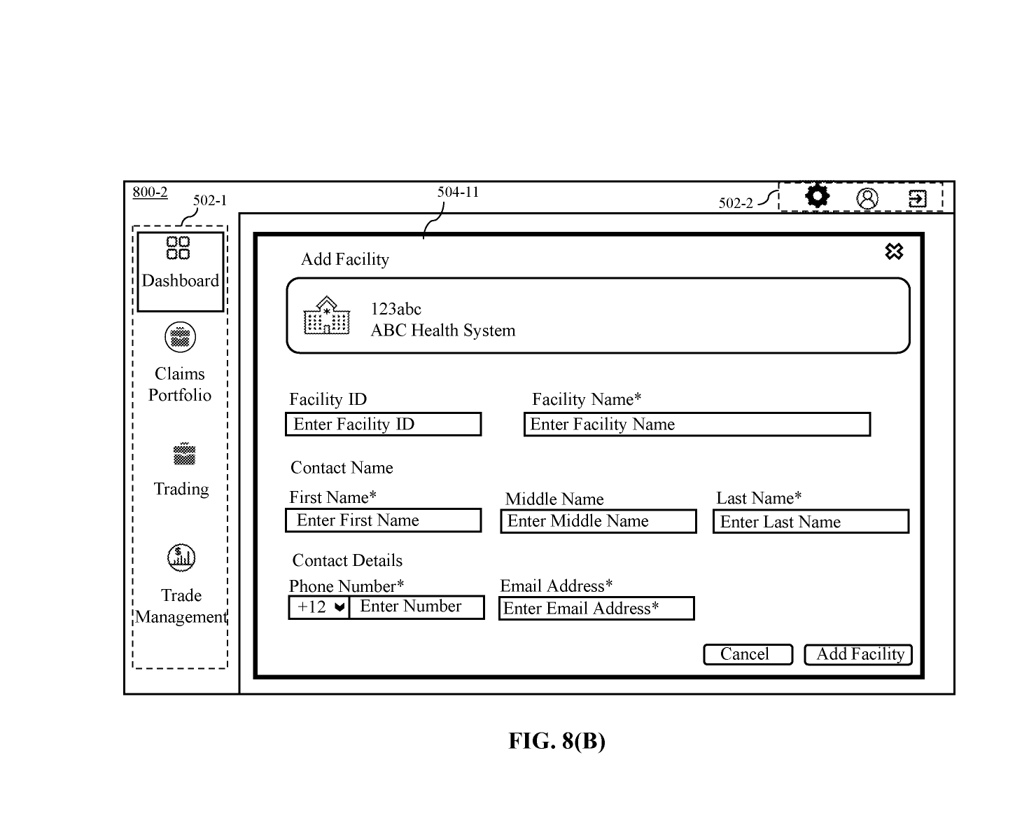

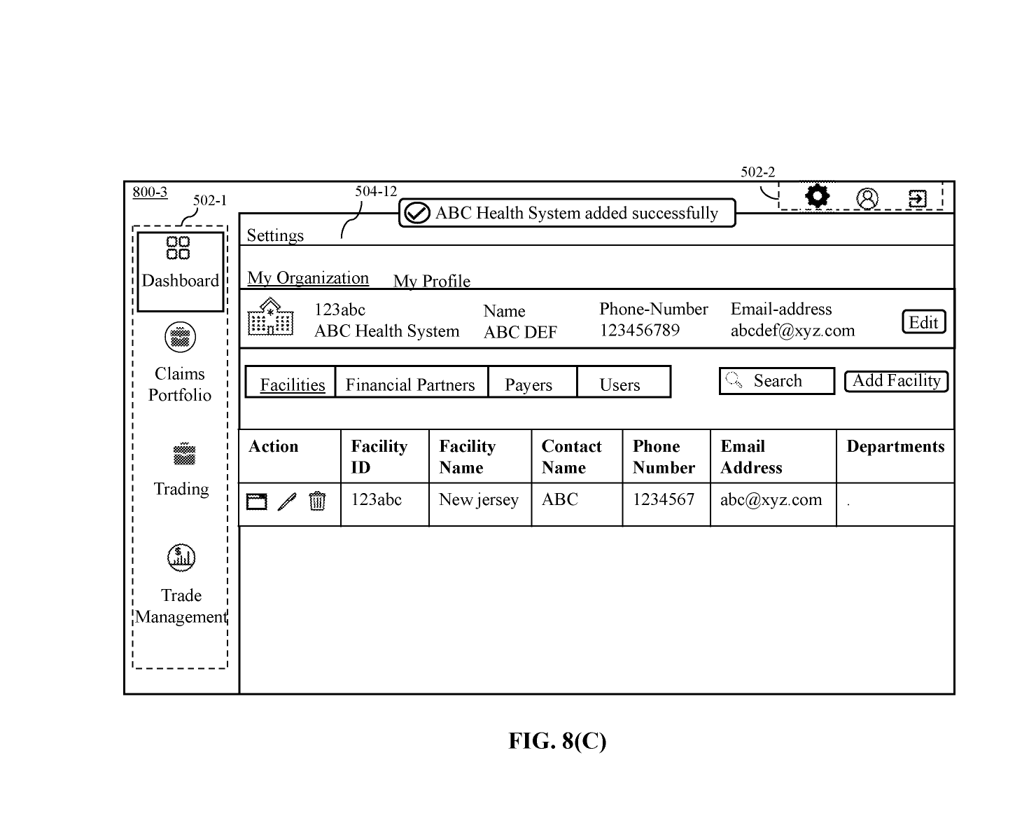

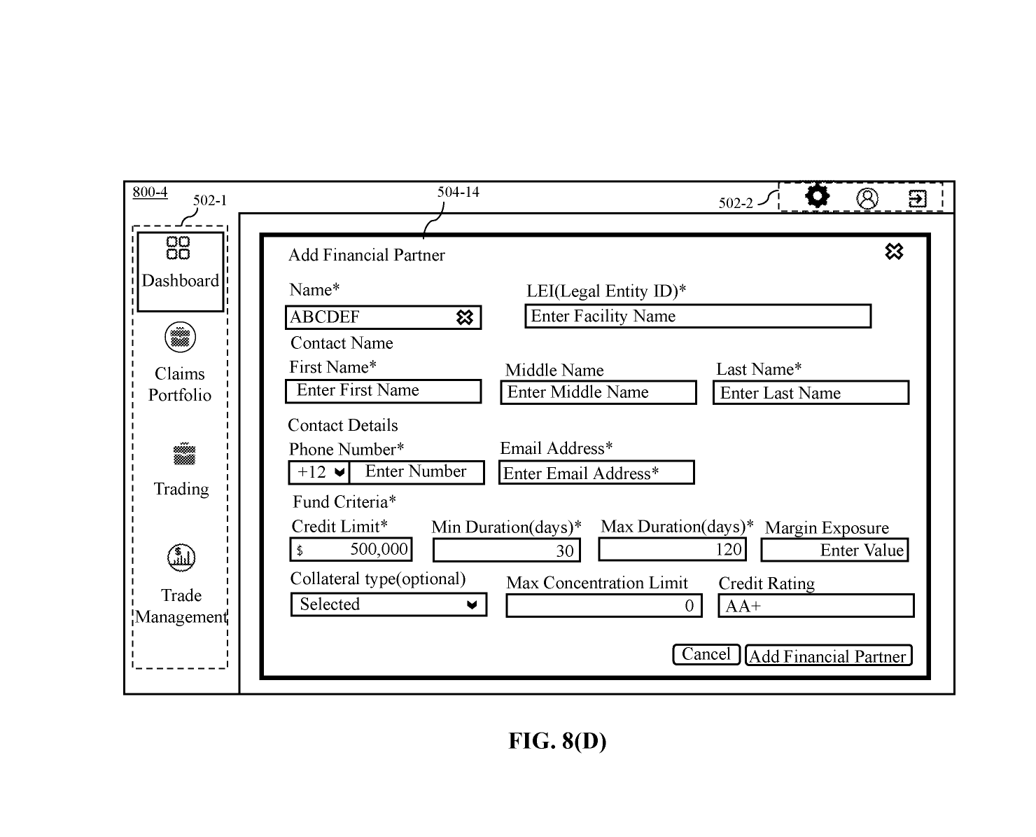

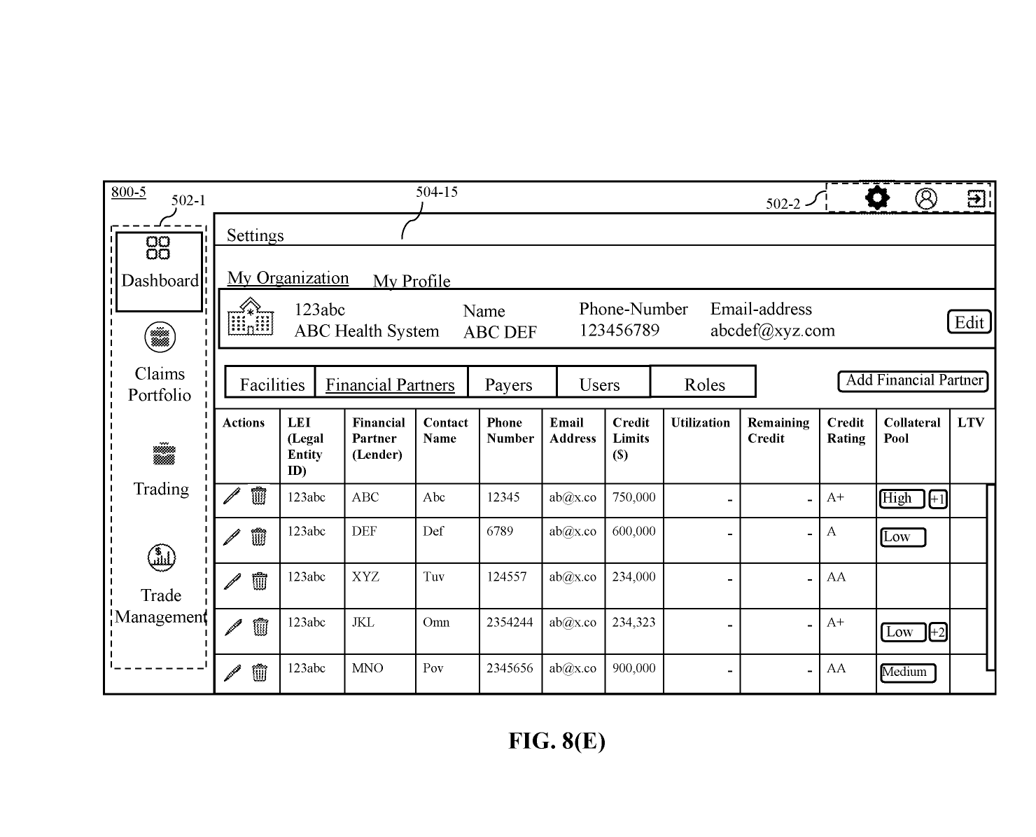

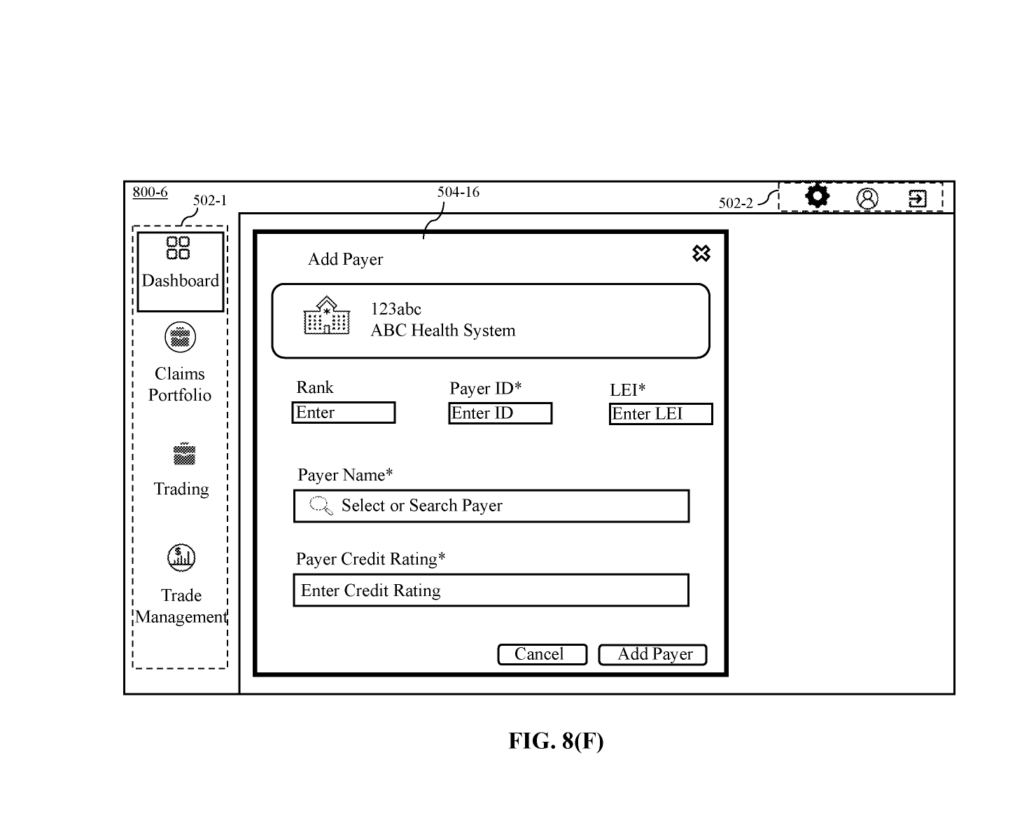

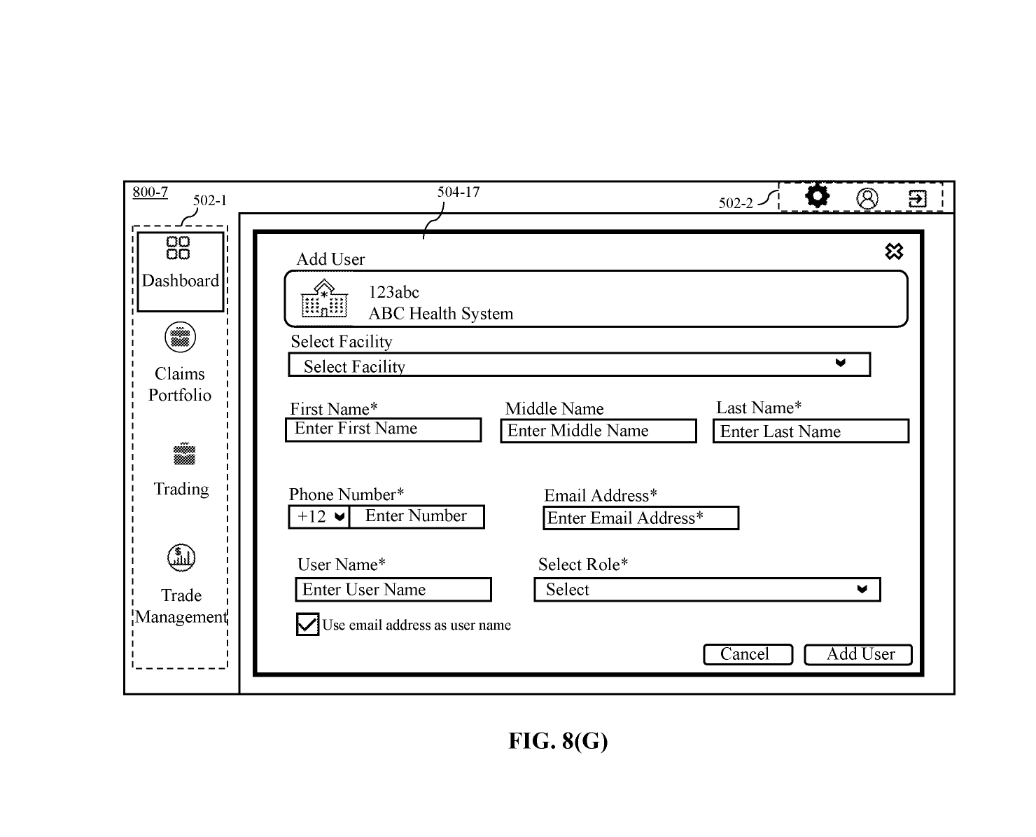

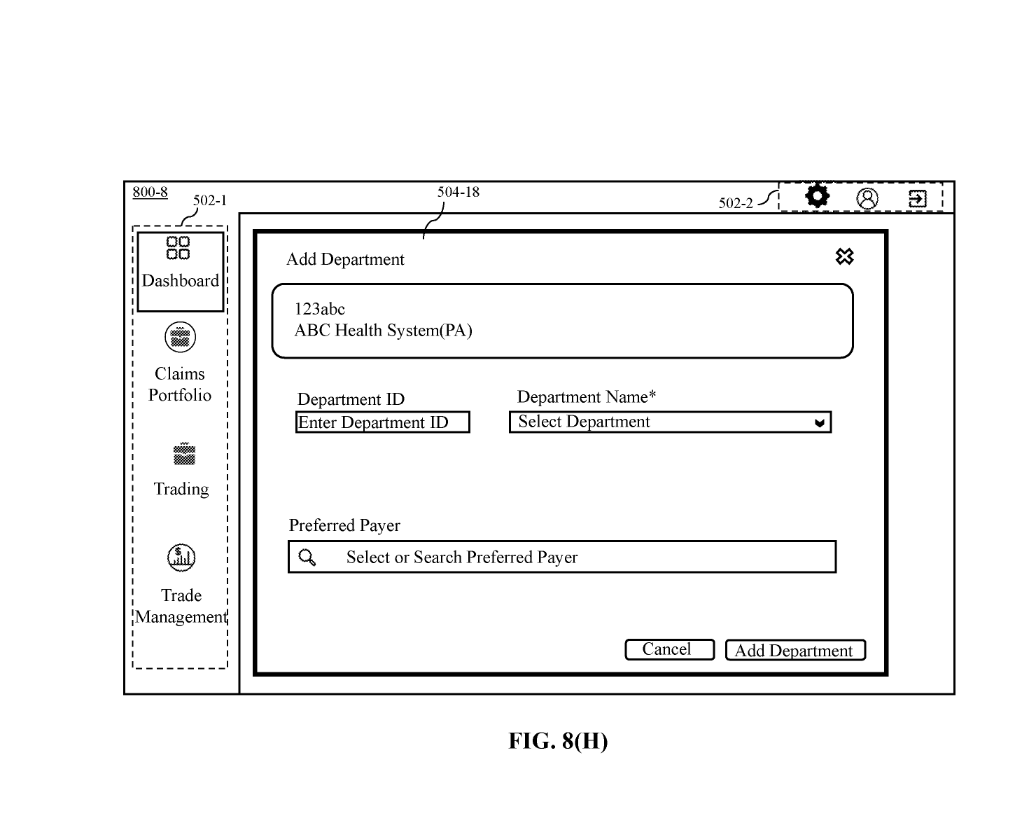

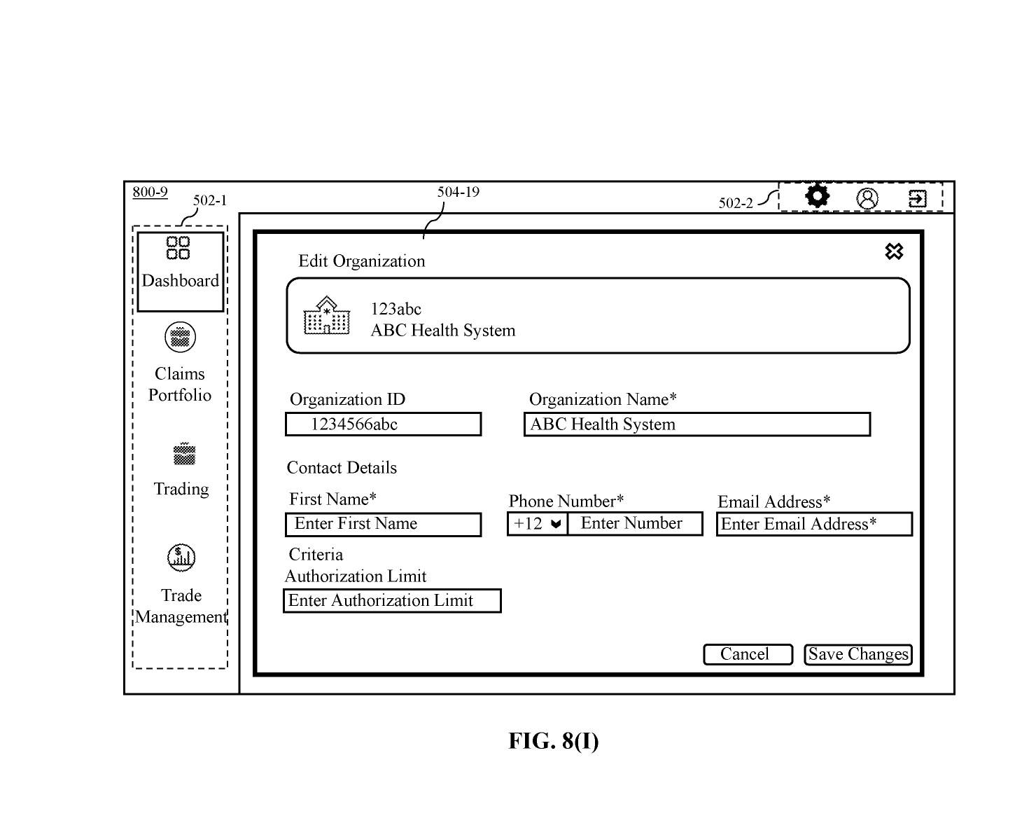

In some other aspects of the present disclosure, the profile generator 203 may further be configured to generate dashboard elements (e.g., data input elements and/or data display elements) to facilitate the user to provide input(s) and receive output(s) related to user details. For example, the profile generator 203 may generate dashboard elements to add, edit, and/or display details corresponding to the medical facility (i.e., corresponding to the end user device 102), the primary client 116, and the secondary client 118 (presented later from FIG. 8(A) through FIG. 8(I).

The data exchanger 204 may be configured to enable exchange of data and/or instruction(s) between the server memory 122, the primary client devices 104, the secondary client device 106, the end user device 102, and various other entities of the data processing circuitry 120. Particularly, for collateralization of the medical claims, the data exchanger 204 may be configured to receive request(s) to collateralize the medical claim(s) corresponding to medical service(s) rendered by the medical facility, from the end user device 102. The request to collateralize the medical claim may include details of the medical claim and details of preferred primary client(s) 116 to collateralize the medical claim. The data exchanger 204 may further be configured to retrieve a historical claim data corresponding to medical claim settlements from the server memory 122. In some aspects of the present disclosure, the historical claim data may be stored in an external database (not shown). In such a scenario, the data exchanger 204 may be configured to generate a data fetch signal for the external database to retrieve the historical claim data from the external database. In some aspects of the present disclosure, the request to collateralize the medical claim(s) may correspond to resource exchange between the medical facility and the primary clients 116.

In some other aspects of the present disclosure, the data exchanger 204 may further be configured to receive trade generation request(s) for exchange of monitory resources of the secondary client 118 with collateralized medical claims of the medical facility. The trade generation request(s) may include a net collateral value, details of the secondary client 118, and a preferred risk category for the medical claim(s) to be exchanged for resources. Moreover, the data exchanger 204 may be configured to exchange data and/or instructions with the ML models 110 which may provide Artificial intelligence (AI) support for collateralization of the medical claim(s). For managing the resources of the secondary client 118, the data exchanger 204 may be configured to retrieve a resource exchange entry from the server memory 122. The resource exchange entry may correspond to exchange of the resources of the secondary client 118 for collateralized medical claim(s) associated with a medical facility.

The data exchanger 204 may further forward the resource exchange entry to various other entities of the data processing circuitry 120 for managing (or updating) the resource exchange between the secondary client 118 and the medical facility. Moreover, the data exchanger 204 may also be configured to share an updated resource exchange entry with the server memory 122.

For managing the resource exchange between the medical facility and the secondary client 118, the data estimator 208 may be configured to retrieve a set of input parameters from each medical claim of the collateralized medical claims in the resource exchange entry. The set of input parameters for each medical claim may include a claim age value of the medical claim and a days to pay (DTP) value for the medical claim. The set of input parameters may further include details of the primary client 116 associated with the medical claim such as the ranking of the primary client 116, the rating of the primary client 116, and the status of the primary client 116. In some aspects of the present disclosure, the details of the primary client 116 may dynamically change based on an anomaly towards payment for the collateralization of historical medical claim(s). In some aspects of the present disclosure, the set of input parameters may further include a claim identifier, a claim amount, a claim date, and a department listed on the medical claim. Aspects of the present disclosure are intended to include or otherwise cover any type of healthcare parameters that may be determined from a medical claim as the set of input parameters of the medical claim, without deviating from the scope of the present disclosure.

The data estimator 208 may further be configured to determine, through a first Machine Learning (ML) model 110 from the ML models 110, a set of output parameters for each medical claim in the resource exchange entry using the set of input parameters and a historical claim data. The historical claim data may include information of medical claim settlements used to train the first ML model 110. The set of output parameters for the medical claim may include, but are not limited to, a risk score for the medical claim, an expected claim settlement date, and a collateral value for the medical claim. Aspects of the present disclosure are intended to include or otherwise cover any type of output parameters in the set of output parameters for the medical claim, as may be determined by the first ML model 110 to collateralize the medical claim, without deviating from the scope of the present disclosure.

The claim age value corresponds to a duration between a present temporal value and the claim date, and the DTP value corresponds to a duration between the present temporal value and the estimated date of payment (i.e., an expected claim settlement date). The present temporal value may be determined by the internal clock 214, that is configured to keep track of time and calendar date. In some aspects of the present disclosure, the data estimator 208 may be configured to determine an estimated date of payment for the medical claim using the first ML model 110, based on the set of input parameters of the medical claim. The data estimator 208 may further determine the DTP value based on a difference between the estimated date of payment and the present temporal value (i.e., present calendar date). Particularly, the risk score and the collateral value for each medical claim dynamically change based on variation(s) in the claim age value of the medical claim, the days to pay (DTP) value for the medical claim, and/or a new claim settlement entry in the historical claim data for training the first ML model 110. Specifically, the risk score of each medical claim in the resource exchange entry may change periodically, continuously, or dynamically (as may be determined through the first ML model 110) due to increase in the claim age value, decrease in the DTP value, and/or addition of the new claim settlement entry in the historical claim data. Moreover, the data estimator 208 may alter the collateral value of the medical claim(s) in the resource exchange entry with a change in the risk score of the medical claim(s).

Based on the risk score value, the data estimator 208 may further assign a risk category (hereinafter interchangeably referred to as risk status) to each medical claim. For example, when the risk score is between a range of 0 to 5, the data estimator 208 may assign ‘low risk’ status to the medical claim. When the risk score is between a range of 6-10, the data estimator 208 may assign a ‘medium risk’ status to the medical claim. Moreover, when the risk score is between a range of 11-15, the data estimator 208 may assign a ‘high risk’ status to the medical claim. Furthermore, when the risk score is between a range of 16-20, the data estimator 208 may assign a ‘very high risk’ status with the medical claim. In some aspects of the present disclosure, based on the dynamic risk score, the data estimator 208 may further be configured to update the collateral value for each medical claim. The data estimator 208 may further be configured to determining a net collateral value of the medical claims by summing the collateral value of each medical claim of the resource exchange entry.

The trade analyzer 206 may be configured to iteratively retrieve the risk score and/or the risk status of each medical claim of the resource exchange entry from the data estimator 208. The trade analyzer 206 may further be configured to determining whether the risk score of a collateralized medical claim of the resource exchange entry exceeds a risk score threshold value. Preferably, the risk score threshold value may be ‘16’ or may correspond to ‘very high risk’ status of the medical claim. The trade analyzer 206 may be configured to determine a scenario when the risk score of a first medical claim of the resource exchange entry exceeds the risk score threshold value. In response, the trade analyzer 206 may be configured to generate a high-risk claim trigger for the data estimator 208 and the trade generator 210. In reception of the high-risk claim trigger, the trade generator 210 may be configured to remove the first medical claim from the resource exchange entry. Moreover, the data estimator 208 may be configured to update the net collateral value of the resource exchange entry, based on the removal of the first medical claim from the collateralized medical claims in the resource exchange entry.

The trade analyzer 206 may further be configured to determine whether the collateral value for a medical claim from the resource exchange entry is received by the medical facility from the primary client 116. The trade analyzer 206 may further be configured to determine another scenario when the collateral value for a second medical claim included in the resource exchange entry is received by the medical facility from the primary client 116. In response, the trade analyzer 206 may be configured to generate an invalid claim trigger for the data estimator 208 and the trade generator 210. In reception of the invalid claim trigger, the trade generator 210 may be configured to remove the second medical claim from the resource exchange entry. Moreover, the data estimator 208 may be configured to update the net collateral value of the resource exchange entry, based on the removal of the second medical claim from the collateralized medical claims in the resource exchange entry.

The trade analyzer 206 may further be configured to iteratively receive the net collateral value of the collateralized medical claims upon every update to the net collateral value of the collateralized medical claims in the resource exchange entry. Furthermore, the trade analyzer 206 may be configured to determine a difference between the net collateral value and a collateral exchange value for the resource exchange entry. The collateral exchange value is determined by the data estimator 208 at a time instance corresponding to a generation of the resource exchange entry and is lower than the net collateral value by a margin exposure value at the time instance. In some aspects of the present disclosure, the margin exposure value may be selected by the secondary client 118 at the time instance of generation of the resource exchange entry (i.e., a first instance of resource exchange between the medical facility and the secondary client 118) and may be equal to a percentage of the net collateral value. In simpler words, the collateral exchange value may be a loan amount that the secondary client 118 may provide in exchange of the collateralized medical claims, which is lower than the net collateral value of the medical claim at the first instance of resource exchange by the margin exposure value.

Moreover, the trade analyzer 206 may be configured to determine a scenario when the difference between the net collateral value and the collateral exchange value is less than a difference threshold value. Particularly, the trade analyzer may check whether ‘the net collateral value <= the resource exchange value - (the margin exposure % * the resource exchange value)’ to determine that the difference between the net collateral value and the collateral exchange value is less than a difference threshold value. In such a scenario, the trade analyzer 206 may generate an unstable-trade trigger for the data estimator 208 and the trade generator 210. In reception of the unstable-trade trigger, the trade generator 210 may be configured to determine new medical claim(s) from collateralized medical claims (not included in the resource exchange entry) associated with the medical facility using a second ML model 110 from the ML model(s) 110. The new medical claim(s) may compensate for a change in the net collateral value due to ineligibility of the medical claim(s) to be collateralized or decrease in the net collateral value of the resource exchange entry due to removal of the first medical claim and/or the second medical claim from the collateralized medical claims in the resource exchange entry. Moreover, the trade generator 210 may be configured to update the resource exchange entry by adding the new medical claim(s) to the collateralized medical claims. In some aspects of the present disclosure, the trade generator 210 may replace the first medical claim and/or the second medical claim from the collateralized medical claims with the new medical claim(s). In some other aspects of the present disclosure, the trade generator 210 may replace all medical claims in the resource exchange entry with a new set of collateralized medical claims determined through the second ML model 110.

The trade generator 210 may further be configured to generate a resource exchange update request for the secondary client 118 using the updated resource exchange entry. The trade analyzer 206 may be configured to determine whether a resource exchange acknowledgement is received from the secondary client 118 in response to the resource exchange update request. In a scenario, when the trade analyzer 206 determines that the resource exchange acknowledgement is received from the secondary client, the trade analyzer may generate a trade-update trigger for the data exchanger 204 that enables the data exchanger 204 to retrieve the updated resource exchange entry from the trade generator 210 and store the updated resource exchange entry into the server memory 112.

In some aspects of the present disclosure, the trade generator 210 may receive selection input(s) from the secondary user 118 via the data exchanger 204. The selection input(s) may correspond to resource exchange parameters such as a spread value of the resource exchange, a timespan for returning the resources, interest rate value(s) for the timespan, a percentage to loan value, and benchmark rate etc. The trade generator 210 may further determine a funded notation (i.e., associated with the collateral exchange value), an interest amount, and the margin exposure value based on the selection input(s).

In some aspects of the present disclosure, when the selection input(s) match with a predefined criterion, the trade generator 210 may be configured to generate a trade authentication trigger for the secondary client 118. The trade generator 210 may further be configured to determine whether a trade acknowledgement is received from the secondary client 118 in response to the trade authentication trigger. Furthermore, the trade generator 210 may be configured to generate the resource exchange entry when the trade acknowledgement is received from the secondary client 118, else discard the resource exchange.

In some aspects of the present disclosure, the trade analyzer 206 may further be configured to assign a resource-exchange state to the resource exchange entry. For example, when the trade analyzer 206 determines that the collateral value for the second medical claim is received by the medical facility from the primary client device 104, the trade analyzer 206 may generate a trade status update signal for the trade generator 210 to change the status of the second medical claim from “Open” to “Paid”. In another exemplary scenario, when the trade analyzer 206 determines that the resources are returned to the secondary client 118 by the medical facility within a predefined time (determined at the first instance of the resource exchange), the trade analyzer 206 may change the resource-exchange status of the resource exchange entry to 'matured' that enables the medical claims to be collateralized again. The trade analyzer 206 may further be configured to determine the resource exchange status of the resource exchange entry iteratively (i.e., periodically or continuously). The trade analyzer 206 may be configured to assign a trade identifier to the resource exchange entry based on the determined resource-exchange status. Preferably, the trade identifier may be one of ‘authorization’, ‘authorized’, ‘pending approval’, open’, rejected’, ‘matured’, and ‘cancelled’.

The portfolio constructor 212 may be configured to generate a risk profile for the resource exchange entry based on the risk scores of the medical claims in the resource exchange entry. The portfolio constructor 212 may further be configured to update the risk profile for the resource exchange entry based on an update in the risk scores of the collateralized medical claims in the resource exchange entry. Furthermore, the portfolio constructor 212 may be configured to generate claim-summary report(s) for the resource exchange entry that depicts information related to lifetime events of the collateralized medical claims in the resource exchange entry such as risk scores, risk statuses, collateral values, and the like. The risk profile and/or the claim-summary report(s) may be rendered to the end user 114 through the end user device 102 and/or the secondary client 118 through the secondary client device 106 to enable them for making informed selection(s) for the resource exchange.

The portfolio constructor 212 may further be configured to generate dashboard portfolio(s) of medical claim(s) to be presented to the end user device 102 associated with the medical facility and/or the secondary client device 106. Particularly, the portfolio constructor may receive a dashboard request from the user device 400. The dashboard request may include user defined input(s) corresponding to a medical facility identifier and/or a secondary client identifier. The portfolio constructor 212 may further be configured to determine, using a third ML model 110 from the ML models 110, entries stored in the server memory 112 based on the dashboard request. The entries may correspond to one dashboard entries, one or more resource exchange entries, or a combination of them, corresponding to the user defined input. Furthermore, the portfolio constructor 212 may generate a portfolio generation trigger that enables the entries to be rendered (displayed or presented) on the user device.

Various components of the data processing circuitry 120 are presented to illustrate the functionality driven by the data processing server 108. It will be apparent to a person having ordinary skill in the art that various components in the data processing circuitry 120 are for illustrative purposes and not limited to any specific combination of hardware circuitry and/or software.

The server memory 122 may be configured to store data corresponding to system 100. In some aspects of the present disclosure, server memory 122 may be segregated into multiple repositories that may be configured to store a specific type of data. In the exemplary embodiment as presented through FIG. 2, the server memory 122 may include an instructions repository 216, a claim data repository 218, a dashboard repository 220, a resource-exchange repository 222, a user data repository 224, and a ML data repository 226.

The instructions repository 216 may be configured to store instructions for various components of the data processing server 108. The claim data repository 218 may be configured to store data associated with the collateralized medical claims of the system 100. The dashboard data repository 220 may be configured to store data corresponding to dashboard request(s) from the users. Moreover, the dashboard data repository 220 may store dashboard element(s) generated by the data processing circuitry 120. The resource-exchange repository 222 may be configured to store data associated with resource exchange between the end user 114 and the clients (cumulatively referring to the primary clients 116 and the secondary client 118). The user data repository 224 may be configured to store data associated with registration and/or authentication of users of the system 100. The ML data repository 226 may be configured to retrieve data and/or instruction(s) from the ML models 110 that may be utilized by various components of the data processing circuitry 120 for collateralization of medical claim(s) and/or resource exchange in lieu of the collateralized medical claim(s).

Various components of the server memory 122 are presented for illustration as per the functionality of the data processing server 108. It will be apparent to a person having ordinary skill in the art that various components in the server memory 120 are for illustrative purposes and the scope of the present disclosure is not limited by the specific repositories as presented herein through FIG. 2. The server memory 122 may include any count and/or type of data storage repositories, without deviating from the scope of the present disclosure.

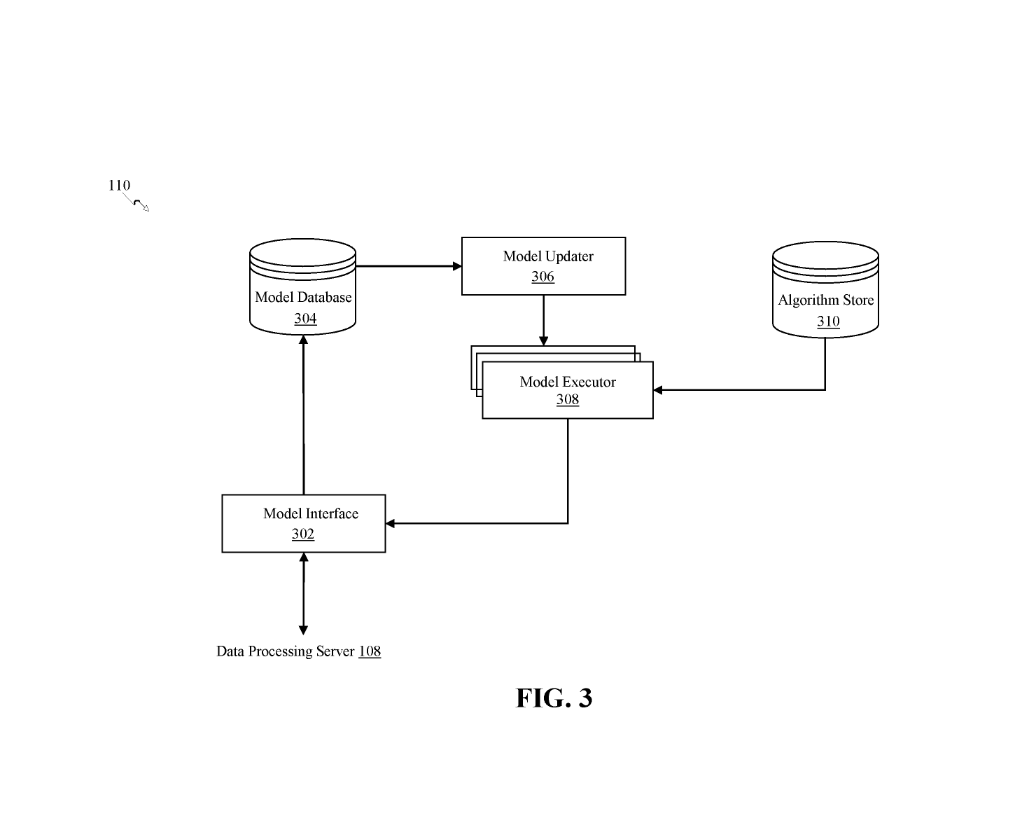

FIG. 3 is a block diagram that depicts a machine learning (ML) model 110 to collateralize the medical claims and manage resource exchange between the medical facility and the clients, according to an exemplary embodiment. The ML model 110 may include a model interface 302, a model database 304, a model updater 306, a model executor 308, and an algorithm store 310. In the exemplary embodiment, the first through third ML models 110 (as discussed in FIG. 2) may be designed in accordance with the ML model 110 as presented herein.

The model interface 302 may receive training data based on the functionality of various components of data processing circuitry 120. The model interface 302 may further send model-generated output(s) to the data processing server 108. Furthermore, the model interface 302 may receive feedback data from the data processing server 108 and may transmit the feedback data to model database 304. The model updater 306 may access the feedback data to update parameter(s) (such as weights, bias, number of layers, filters, pooling type etc.) of the model executor 308 for training specific collateralization of the medical claims or exchange in resources in lieu of the collateralized medical claims. Additionally, the model interface 302 may receive instruction data from the data processing server 108 and may transmit classified information to the data processing server 108.

The model database 304 may store neural networks, weights of neurons for the neural networks, input data for the neural networks, output data from the neural networks, and the like. Additionally, the model database 304 may transmit a neural network from the stored neural networks to the model updater 306. The model database 304 further sends the feedback data to model updater 306. Based on the feedback data, the model updater 306 may update the parameters of ML model for customized training specific to each functionality of the data processing server 108.

The model executor 308 may receive data from the model updater 306 that includes a customized training regimen specific to each object and the feedback data. Based on the data received from the model updater 306, the model executor 308 may retrieve ML algorithms from the algorithm store 310 to perform operation(s) for the data processing server 108. Particularly, the model executor 308 may include an input neurons layer configured to receive data from the model interface 302, hidden neuron layer(s) configured to propagate the received data for classification, and an output neuron layer configured to depict an output in accordance with the functionality of a component of the data processing server 108. Moreover, the model executor 308 is trained for specific task(s) to classify the input data to generate the output. Each neuron of the model executor 308 may be attached with a weight and a bias, that is determined via training of the ML model 110.

In some aspects of the present disclosure, the model executor 308 may be designed using field programmable gate array (FPGA) and/or application specific integrated chip (ASIC) programmed for a specific ML functionality to support the data processing server 108. In some aspects of the present disclosure, each of the first through third ML models 110 may be designed using Gradient-Boosting (GB) ML models. It will be apparent to a person of ordinary skill in the art that the scope of the ML models 110 is not limited only to use of the GB models. Rather, the scope of the present disclosure is limited to the functionality of the data processing server 108 as presented in FIG. 2, that may be supported by any utilize any ML model existing, or designed later in advancement of the technology, without deviating from the scope of the present disclosure.

In some aspects of the present disclosure, the model executor 308 may transmit indication of a ML algorithm to algorithm store 310. The algorithm store 310 may store multiple ML algorithms. Based on the indication, the algorithm store 310 may transmit the corresponding ML algorithm from the multiple machine learning algorithms to be used by the model executor 308 for collateralization of the medical claims, preparation of dashboard(s), and/or resource exchange between the medical facility and the clients (cumulatively referring to the primary clients 116 and/or the secondary client 118).

FIG. 4 presents a block diagram of the user device 400, in accordance with an exemplary embodiment. The user device 400 may represent any of the end user device 102, the primary client device 104, and the secondary client device 106, in accordance with an exemplary aspect of the present disclosure. According to the exemplary embodiment as presented through FIG. 4, the user device 400 may include a user interface 402, an application console 404, a device processor 406, a device memory 408, a communication interface 410, access point(s) 412, and a communication interface 414, communicatively coupled to each other.

The user interface 402 may include an input interface 416 for receiving input(s) from the user. Examples of the input interface 416 may include, but are not limited to, a touch interface, a mouse, a keyboard, a motion recognition unit, a gesture recognition unit, a voice recognition unit, or the like. Aspects of the present disclosure are intended to include or otherwise cover any type of the input interface 416 including known, related art, and/or later developed technologies without deviating from the scope of the present disclosure. The user interface 402 may further include an output interface 418 for rendering output(s) to the user. Examples of the output interface 418 may include, but are not limited to, a digital display, an analog display, a touch screen display, a graphical user interface, a website, a webpage, a keyboard, a mouse, a light pen, an appearance of a desktop, and/or illuminated characters. Aspects of the present disclosure are intended to include or otherwise cover any type of the output interface 418 including known, related art, and/or later developed technologies without deviating from the scope of the present disclosure.

The application console 404 may be configured as a computer-executable application, to be executed by the user device 400. The application console 404 may include suitable logic, instructions, and/or codes for executing multiple operations of the system 100 and may be controlled (or hosted) by the data processing server 108. The computer executable application(s) may be stored in the device memory 408. In some aspects of the present disclosure, the application console 404 may include an application logic 420, that may include logic, codes, and/or circuitry to control the display through the output interface 418. More particularly, the application logic may be shared with the device processor 406 that controls output(s) rendered through the output interface 418.

The device processor 406 may include suitable logic, instructions, circuitry, interfaces, and/or codes for executing various operations associated with the user device 400. In some aspects of the present disclosure, the device processor 406 may utilize processor(s) such as Arduino or raspberry pi and/or the like. Further, the device processor 406 may be configured to control operation(s) executed by the user device 400 in response to the input received at the user interface 402 from the user. Examples of the device processor 406 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Aspects of the present disclosure are intended to include or otherwise cover any type of the device processor 406 including known, related art, and/or later developed processing units, without deviating from the scope of the present disclosure.

The device memory 408 may be configured to store logic, instructions, circuitry, interfaces, and/or codes of the device processor 406, data associated with the communication controller 410, data associated with the user device 400, and data associated with the system 100. Examples of the device memory 408 may include, but are not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Aspects of the present disclosure are intended to include or otherwise cover any type of the device memory 408 including known, related art, and/or later developed memories, without deviating from the scope of the present disclosure. In some aspects of the present disclosure, the device memory 408 may store application objects 422 specific to the computer-executable application running through the application console 404. The device memory 408 may further store instruction objects for operations of various components of the user device 400.

Communication controller 410 may include processing circuitry to enable and/or control the access point(s) 410. The access point(s) 410 generate wireless communication signals that facilitate the communication interface 414 to communicatively couple with network 112.

The communication interface 414 may be configured to enable the user device 400 to communicate with various components of the system 100 over the network 112. Examples of the communication interface 414 may include, but are not limited to, a modem, a network interface such as an Ethernet card, a communication port, and/or a Personal Computer Memory Card International Association (PCMCIA) slot and card, an antenna, a radio frequency (RF) transceiver, amplifier(s), a tuner, oscillator(s), a digital signal processor, a coder-decoder (CODEC) chipset, a Subscriber Identity Module (SIM) card, and a local buffer circuit. It will be apparent to a person of ordinary skill in the art that the communication interface 414 may include any device and/or apparatus capable of providing wireless or wired communication between the user device 400 and the other components of the system 100.

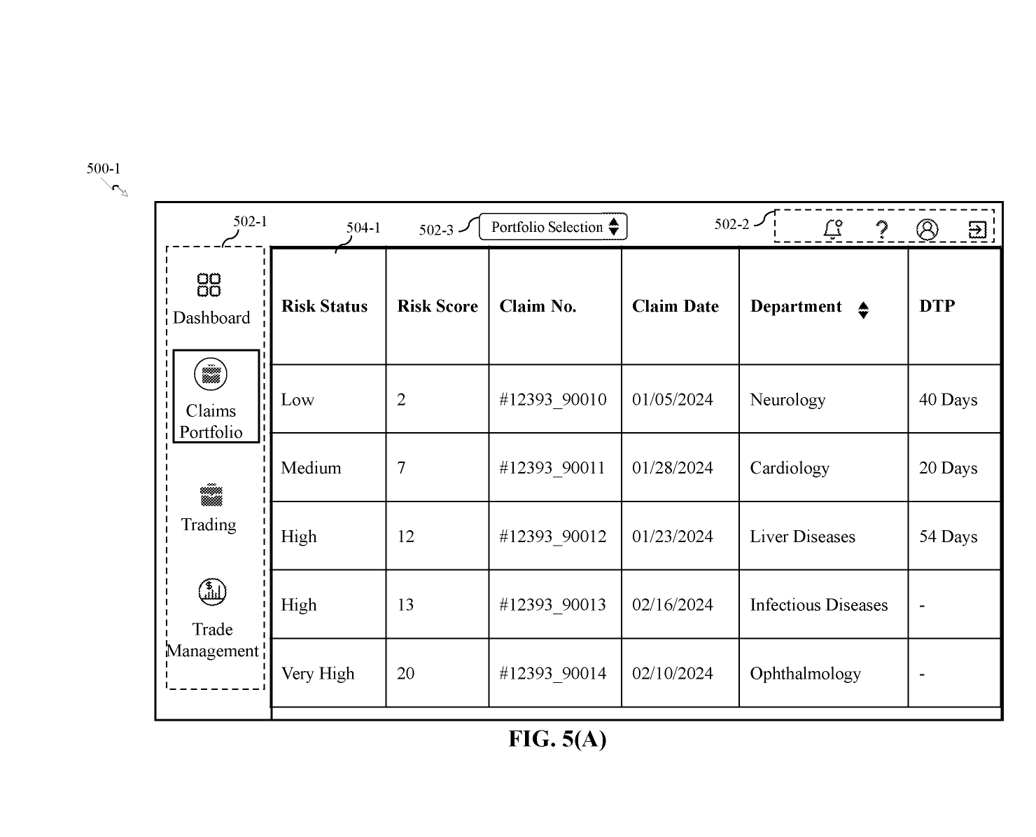

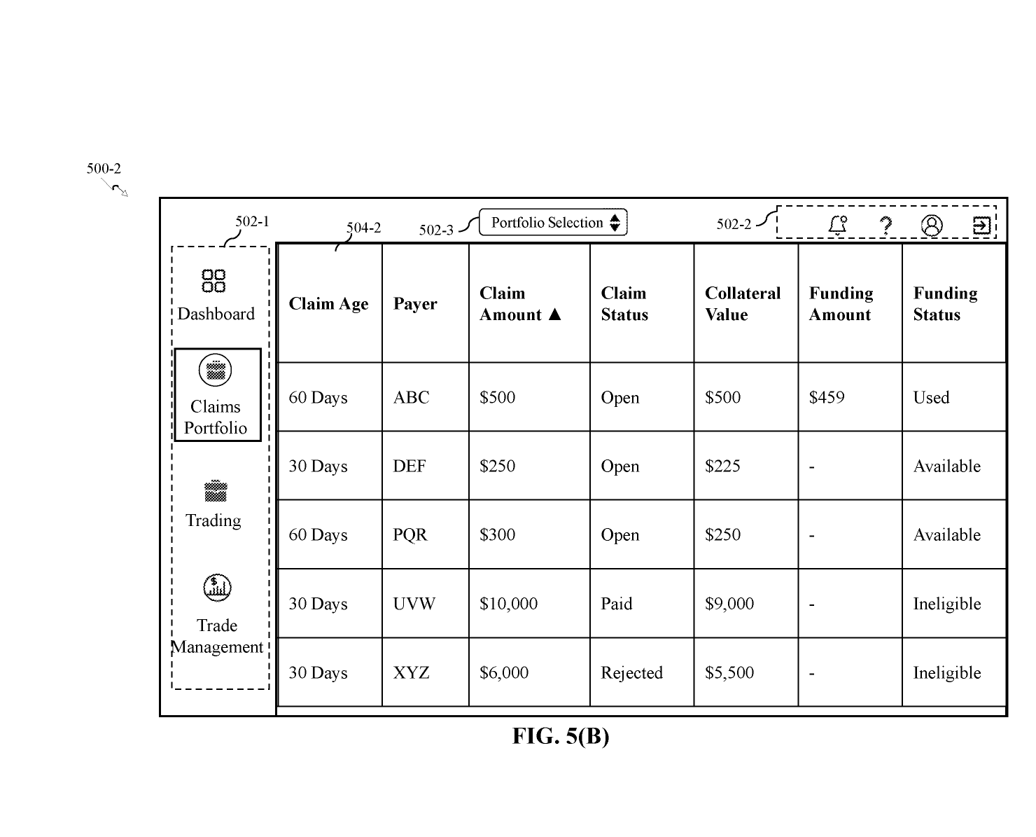

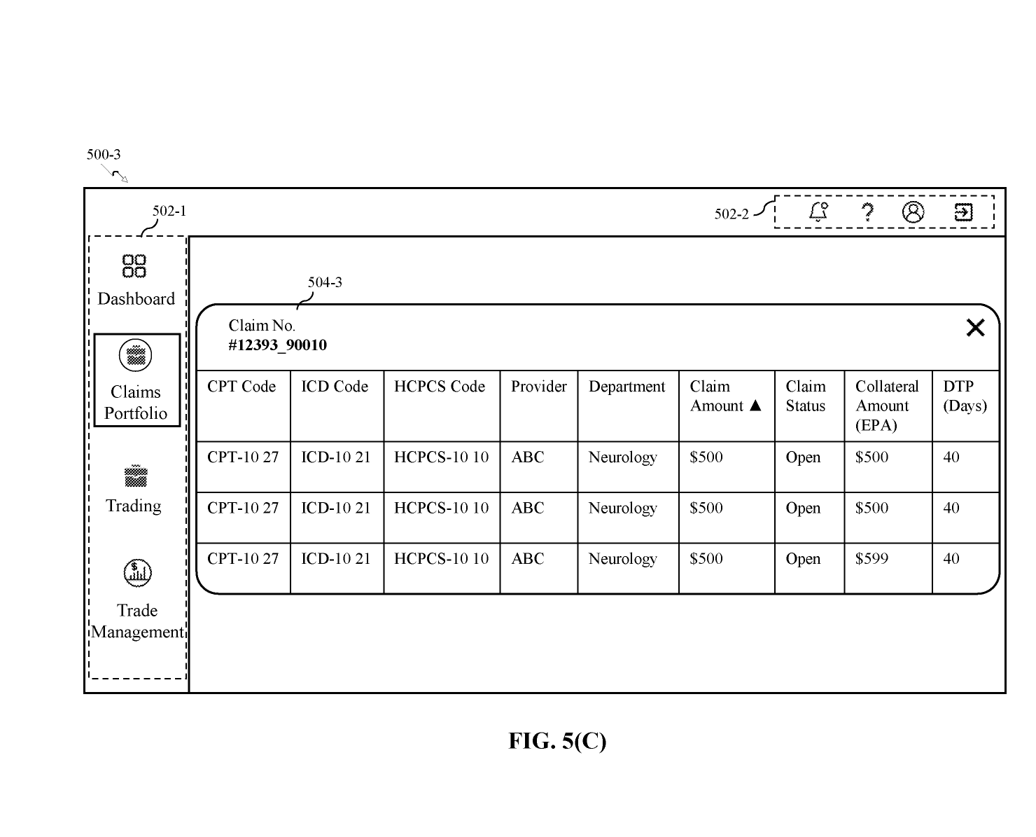

FIGS. 5(A)-5(C) illustrate Graphical User interfaces (GUIs) 500-1 through 500-3 generated by the system 100 and presented through the user device 400 corresponding to generation of claim portfolio for selected medical claims, in accordance with an exemplary aspect of the present disclosure.

More particularly, FIG. 5(A) and FIG. 5(B) illustrate example embodiments of application interfaces (i.e., the GUI 500-1 and GUI 500-2) generated by the system 100. The Application interfaces display dashboards presented through the output interface 418 of the end user device 102 to the end user 114 of the medical facility, in accordance with option(s) selected by the end user 114. The application is operated through the application console 404, controlled by the data processing server 108, and is displayed through the output interface 418. The GUI 500-1 may include elements 502-1, 502-2, 502-3, and 504-1.

The element 502-1 may include selectable option(s) to facilitate the user for selecting an operation to be performed by the system 100. Preferably, the element 502-1 may include a dashboard selection option, a claims portfolio selection option, a trading selection option, and a trade management selection option.

The element 502-2 may include selectable options for the user. Preferably, the element 502-2 may include a notification option that enables the user to view notification(s) for the user generated by the system 100. The element 502-2 may further include a help option that enables the user to input a query for operations of the application interface. Furthermore, the element 502-2 includes a user account option that enables the user to view and/or update user-account information provided by the user while registering with the system 100. Moreover, the element 502-2 includes a logout option that enables the user to log-out the user-account from the application interface. Logging-out may enable the user to log-in to the system using log-in details corresponding to another user-account registered with the system 100.

In the presented aspect of the present disclosure, when the claim portfolio option is selected by the user using the element 502-1, the element 502-3 is presented on the application interface. The element 502-3 may include selectable option(s) to facilitate the user to select option(s) to be displayed through the output interface 418 via the element 504-1. In some aspects of the present disclosure, the options of element 502-3 may include the claim identifier (presented as claim no.) of the medical claim, the set of input parameters of the medical claim, the set of output parameters of the medical claim, and the set of derived output parameters of the medical claim. Based on the user selection through the element 502-3, the system 100 generates display fields for the element 504-1.

In the presented aspect, the element 504-1 is presented to display the risk status, the risk score, the claim identifier (i.e., presented as the claim no.), the claim date, the department, and the DTP value. Moreover, the element 504-2 is presented to display the claim age, the primary client (i.e., presented as payer), the claim amount, status of the claim, the collateral value, a funding amount, and a funding status. It will be apparent to a person skilled in the art that the fields presented through the elements 504-1 and 504-2 are for illustration only, and the scope of the present disclosure is not limited to the. Rather, the elements 504-1 and/or 504-2 may include data fields corresponding to the claim identifier of a medical claim, the set of input parameters of the medical claim, the set of output parameters of the medical claim, and the set of derived output parameters of the medical claim, based on the user selection.

In some aspects of the present disclosure, the system 100 further facilitates the user to view medical descriptive details of various services rendered by the medical facility, presented through a medical claim. The application interface enables the user to click on a medical claim to present the medical descriptive details of the services. FIG. 5(C) presents an application interface (i.e., presented through the GUI 500-3) generated by the system 100, in response to selection of a medical claim for medical descriptive information by the user. The GUI 500-3 includes an element 504-3 that includes medical descriptive details of various services rendered by the medical facility presented in the selected claim. In the presented embodiment, the element 504-3 may include a Current Procedural Terminology (CPT), Healthcare Common Procedure Coding Systems (HCPCS) number, details of healthcare provider, department details, claim amount, claim status, collateral amount, and DTP details, for each service of the medical claim. It will be apparent to a person of ordinary skill in the art that the fields for medical descriptive information of the medical claim are for illustration only, and the scope of the present disclosure is not limited to it. Rather, the element 504-3 may include any type of medical descriptive information of services as may be derived from the medical claim generated by the healthcare facility, without deviating from the scope of the present disclosure.

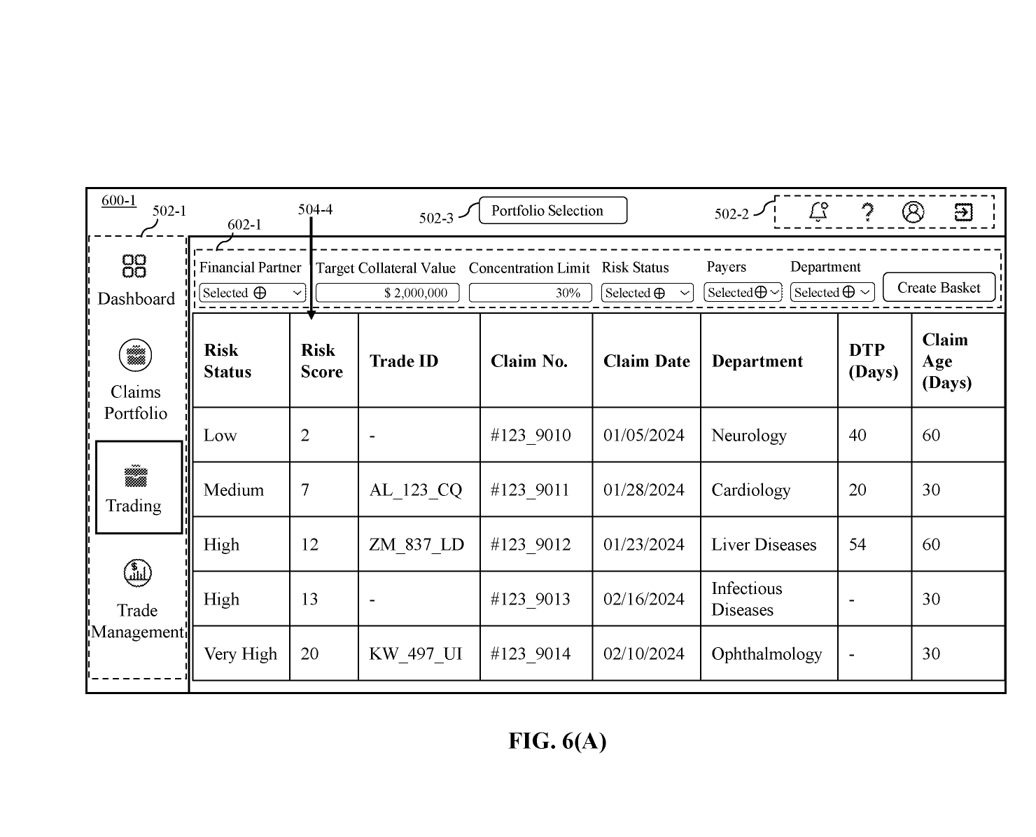

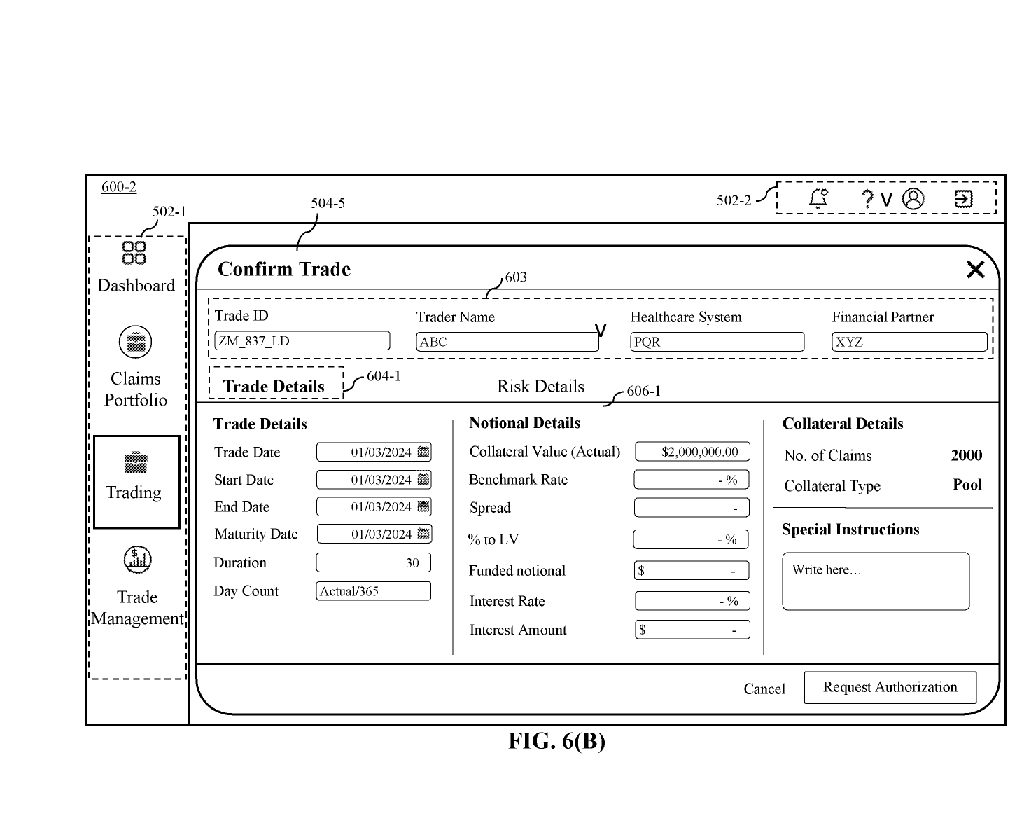

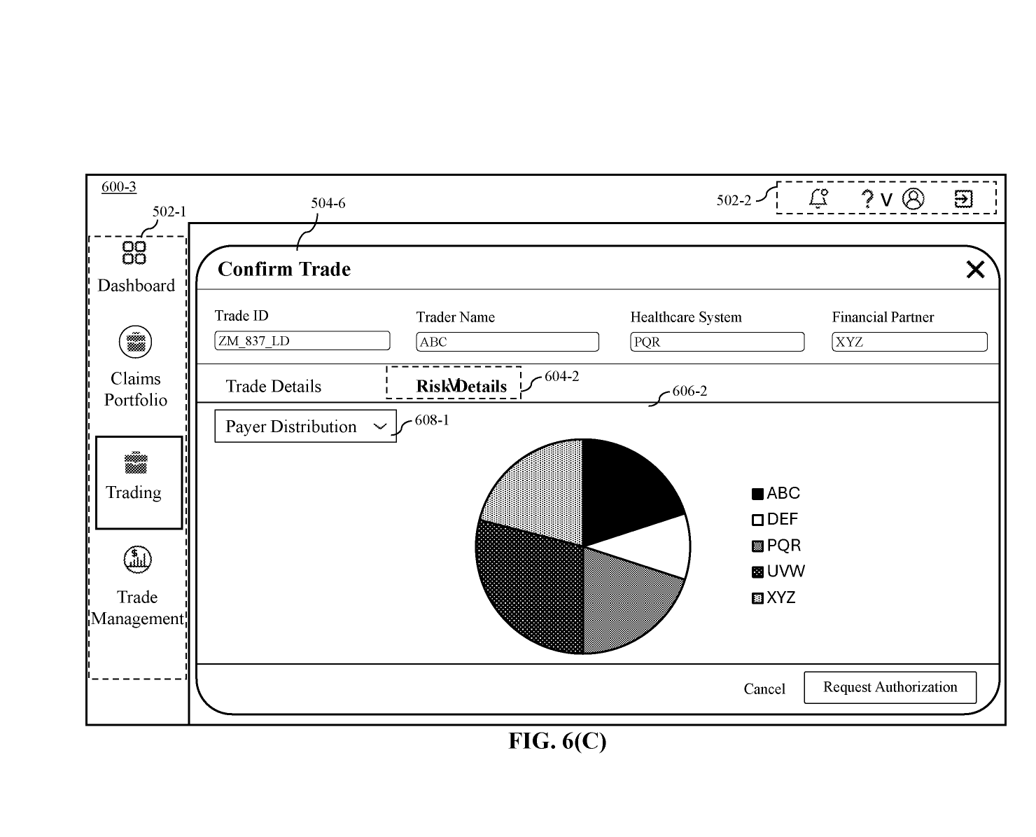

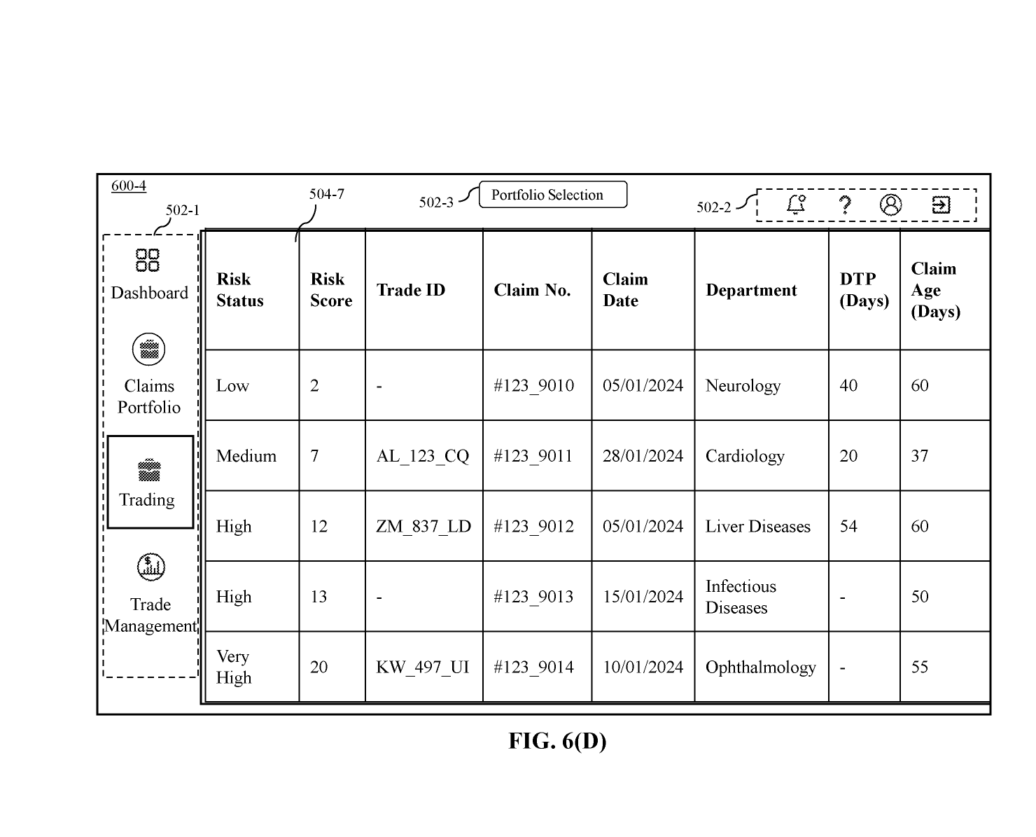

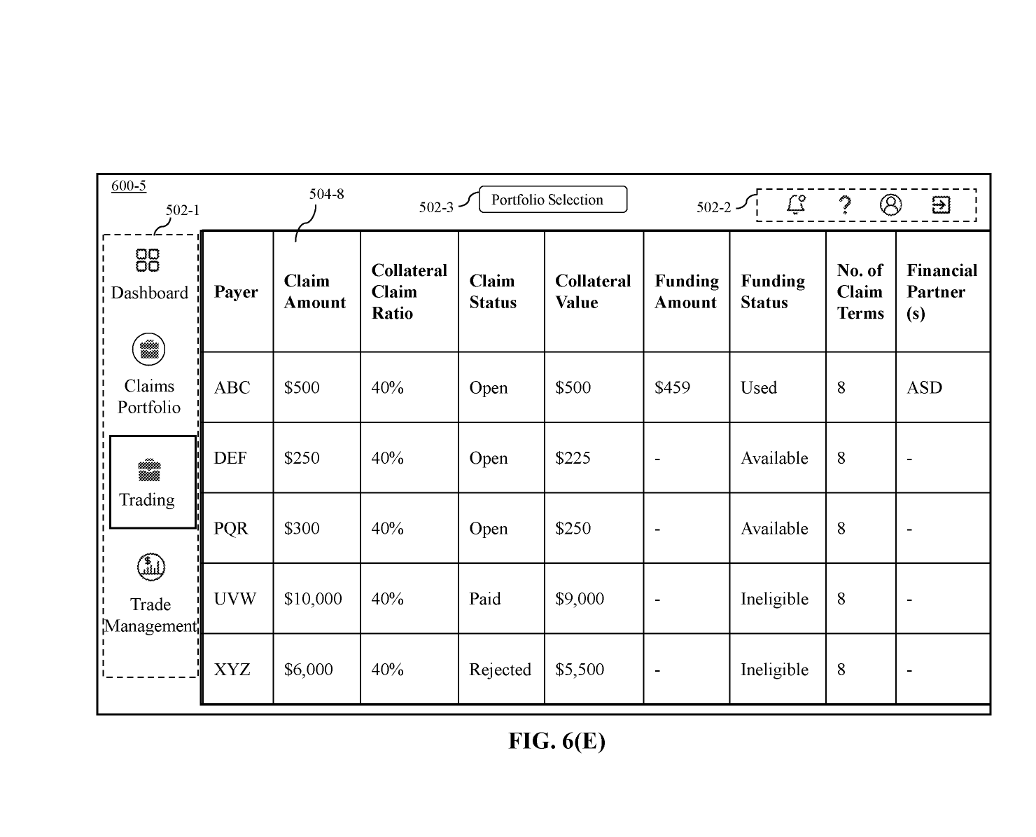

FIGS. 6(A)-(E) illustrate application interfaces (presented through GUIs 600-1 through 600-5) generated by the system 100 and presented through the user device 400 corresponding to resource exchange, in accordance with an exemplary aspect of the present disclosure.

Particularly, FIG. 6(A) illustrates example embodiment of an application interface (i.e., the GUI 600-1) generated by the system 100. The GUI 600-1 is generated by the system 100 in response to a selection of the trading option from the element 502-1 by the user. The GUI 600-1 may include elements 502-1, 502-2, and 502-3. The GUI 600-1 may further include elements 602-1 and 504-4.

The element 602-2 may include selectable option(s) to facilitate the user to provide input(s) for resource exchange. Specifically, the element 602-1 may include an option to select the secondary client 118 (i.e., presented as financial partner), an option to select the target collateral value, an option to select the concentration limit, an option to select the risk status of medical claim(s), an option to select the primary client(s) (presented as payers), and an option to select the department. In accordance with the selection(s) of the user, the element 504-4 is generated by the system 100 and presented through the GUI 600-1 of the application interface. In the presented embodiment, the element 504-4 is presented to include the risk status, the risk score, a trade identifier (trade ID), the claim identifier (Claim ID), the claim date, the department details, and the DTP value of the medical claims determined by the system 100 based on the selection(s) by the user. It will be apparent to a person skilled in the art that the data fields included in the element 504-4 are based on the selection of the data fields by the user through the element 502-3 as presented above, and thus the scope of the present disclosure is not limited to it. Rather, the element 504-4 may include any data fields that may correspond to resource exchange between the medical facility and the secondary client 118, without deviating from the scope of the present disclosure.

The element 602-1 may further include an option to create basket of the medical claims as determined by the system based on the selections by the user from the various options of the element 602-1 and presented through the element 504-4. In an exemplary scenario, when the option to create basket is selected by the user, the application renders another application interface presented through GUI 600-2.

FIG. 6(B) and FIG. 6(C) illustrate example embodiments of application interfaces (i.e., the GUI 600-2 and GUI 600-3) generated by the system 100. The GUI 600-2 includes an element 504-5 that includes sub-element 603 and sub-element 604-1. The sub-element 603 enables the user to select options for selecting entities participating in the resource exchange. The sub-element 604-1 enables the user to select trade-details input as an option. In an exemplary scenario, when the user selects (or clicks on) the sub-element 604-1, a new sub-element 606-1 is generated by the system that is presented by the GUI 600-2. The sub-element 606-1 enables the user to select (or provide) input(s) for resource exchange. Moreover, when the user selects (or provides) inputs for resource exchange to the options of the sub-element 606-1, application renders another application interface presented through GUI 600-3.

The GUI 600-3 includes an element 504-6 that further includes a sub-element 604-2. In some aspects of the present disclosure, the sub-element 604-2 enables the user to view the risk details corresponding to the resource exchange. In an exemplary scenario, when the user selects (or clicks on) the sub-element 604-2, a new sub-element 606-2 is presented on the application interface. The sub-element 602-2 may include selectable option 608-1 that enables selection of risk parameter(s) associated with the resource exchange. Moreover, the sub-element 606-2 may also present the data of the selection through the selectable option 608-1 using various graphical options such as but not limited to graphs, bar graph, pie chart, etc. the element 504-5 and 504-6 further includes an option for request authorization of the resource exchange, that enables the user to generate a request for resource exchange based on the selected (or provided) input(s). In an exemplary scenario, when the user selects the option for request authorization, the application renders to GUI 600-4.

FIG. 6(D) and FIG. 6(E) illustrate example embodiments of application interfaces (i.e., the GUI 600-4 and GUI 600-5) generated by the system 100. The GUI 600-4 includes an element 504-7 that presents resource exchange details based on a selection of option(s) from the element 502-3 by the user. Similarly, the GUI 600-5 includes an element 504-8 that presents resource exchange details based on another selection of option(s) from the element 502-3 by the user. It will be apparent to a person of ordinary skill in the art that the data fields presented through the elements 504-7 and 504-8 are for illustration only, and the scope of the present disclosure is not limited to it. Rather, the elements 504-7 and 504-8 may include any data field related to the resource exchange, as may be selected by the user using the element 502-3.

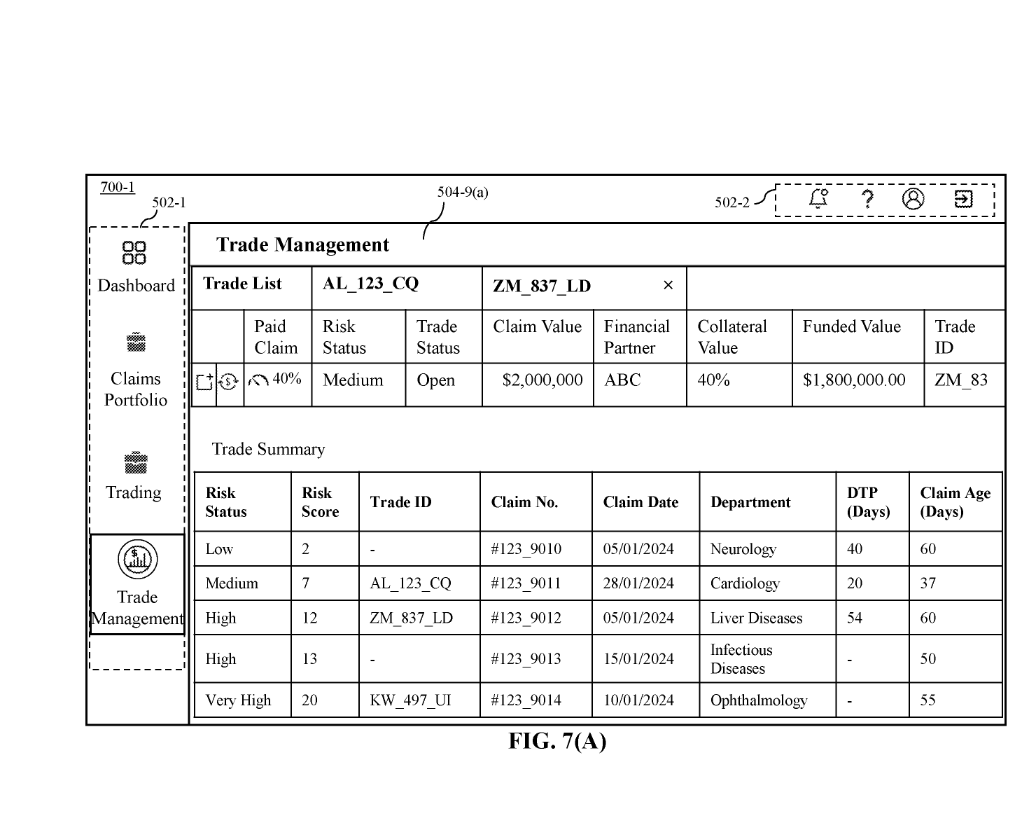

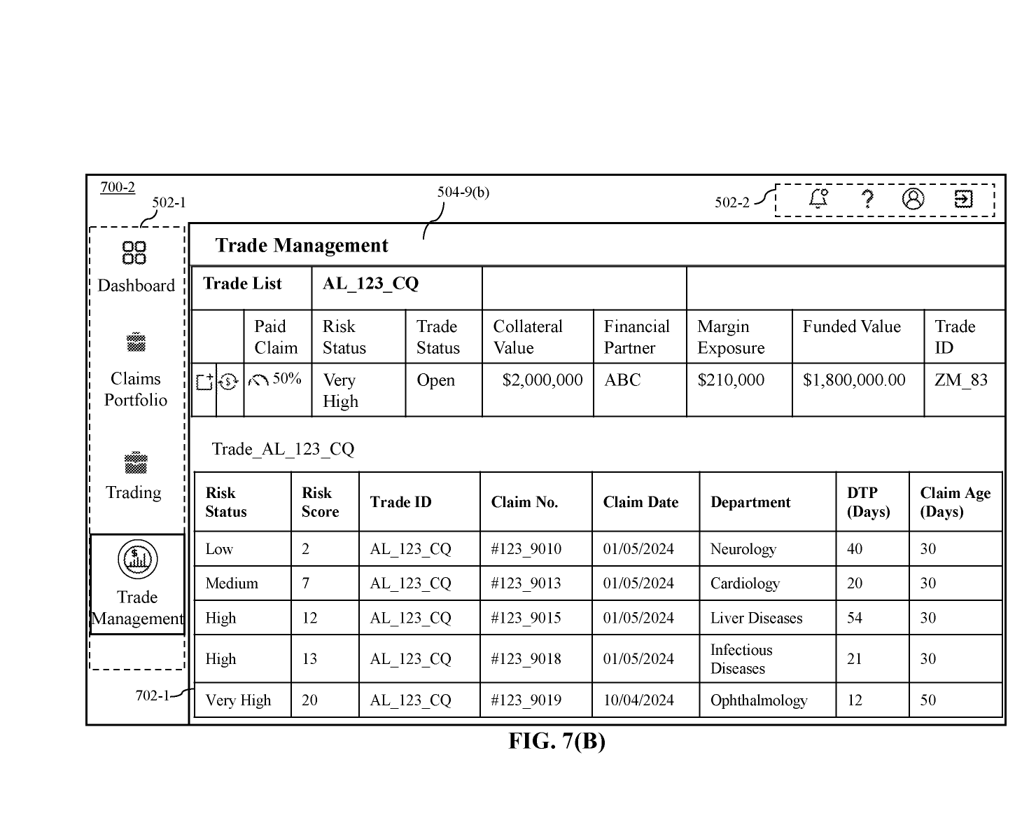

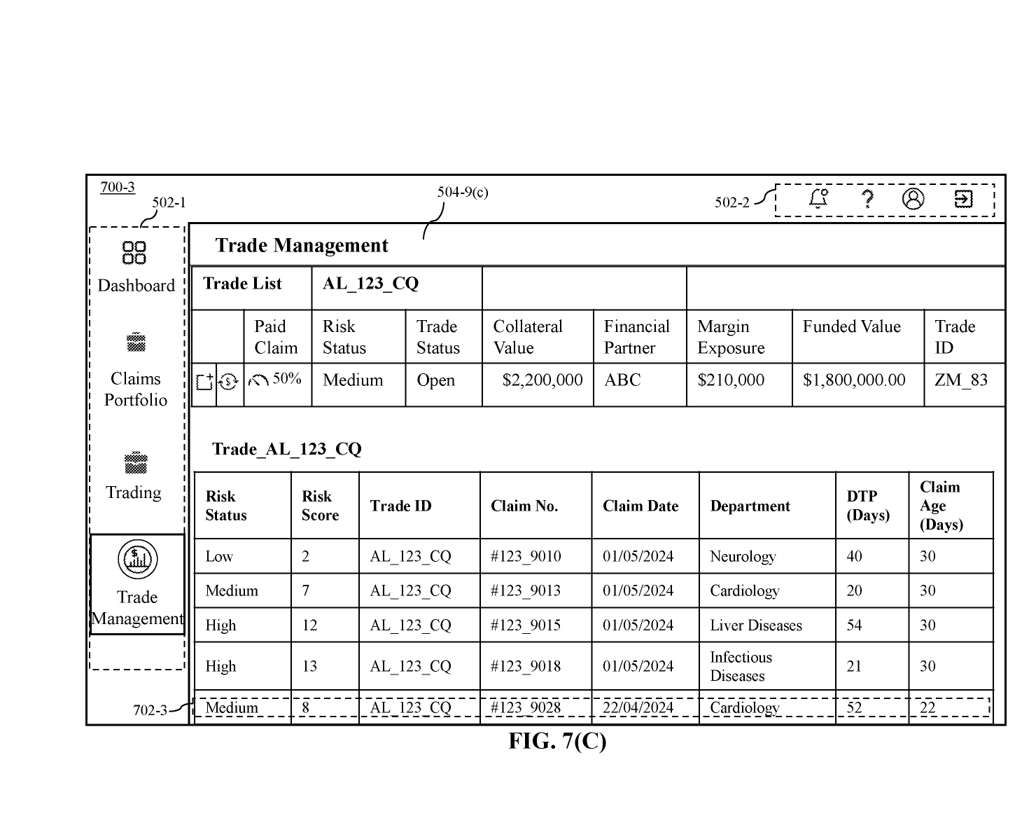

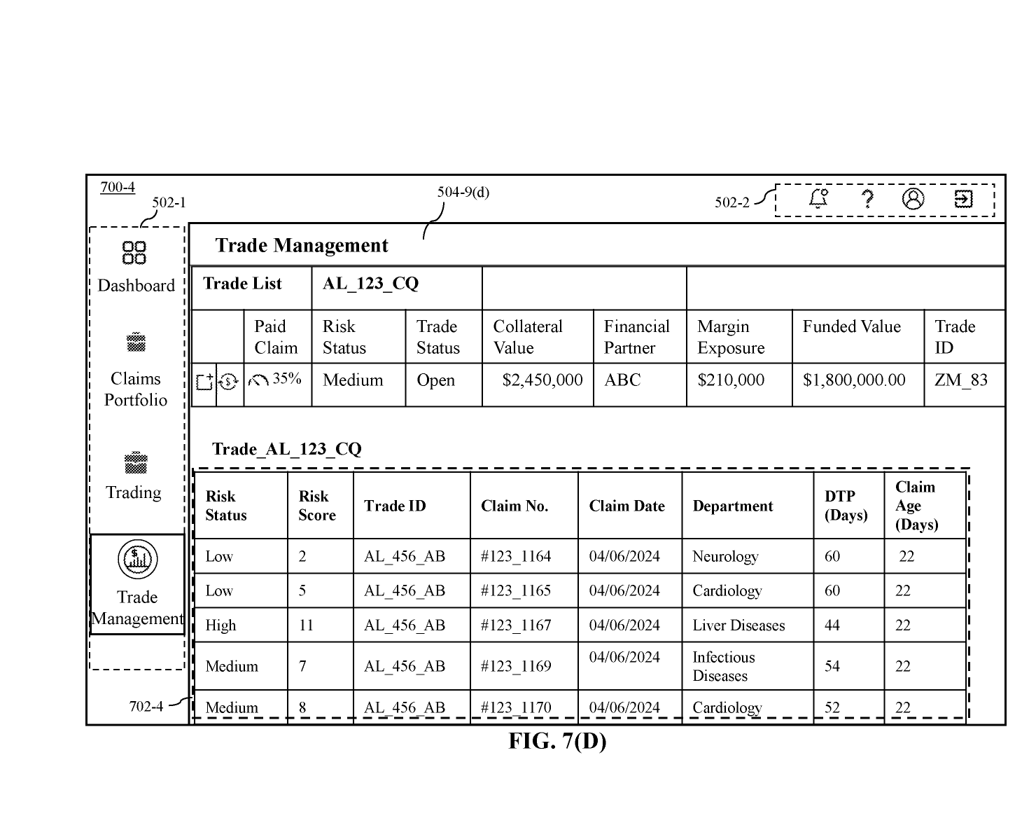

FIGS. 7(A)-7(D) illustrate application interfaces (i.e., presented through GUI 700-1 through GUI 700-4) generated by the system 100 for management of resource exchange between the medical facility and the secondary client 118, in accordance with an exemplary aspect of the present disclosure.

Particularly, FIG. 7(A) illustrates example embodiment of an application interface (i.e., the GUI 700-1) generated by the system 100 and presented on the application interface by a selection of the trade management option from the element 502-1. The GUI 700-1 may include an element 504-9(a) that presents information related to various resource exchanges of the secondary client 118. In the exemplary embodiment presented through FIG. 7(A), the element 504-9(a) includes a list of resource exchanges (presented as trade list) comprising selectable options for each resource exchange associated with the secondary client 118. Upon selection of a resource exchange option by the user, the application interface provides details of the selected resource exchange. The element 504-9(a) may further include a summary of the selected resource exchange (presented as trade summary) that may include details of the medical claim(s) corresponding to the selected resource exchange. In an exemplary scenario, when the difference between the net collateral value and the first monitory value for the first set of medical claims for a resource exchange is less than the margin exposure value, the system 100 may generate a notification for the user, that may be presented to the user by selecting the notification option in the element 502-2. Moreover, the second monitory value, the second set of medical claims and their associated details may be rendered to the user through the element 504-9(a) of the GUI 700-1.

FIG. 7(B) illustrates example embodiment of an application interface (i.e., GUI 700-2) generated by the system 100 and presented on the application interface by a selection of the trade management option from the element 502-1. The GUI 700-2 may include an element 504-9(b) that presents information related to various resource exchanges of the secondary client 118. Particularly, the element 504-9(b) presents a scenario of unstable resource exchange between the secondary client 118 and the medical facility, which can be depicted based on the collateral value, the margin exposure value, and the funded value (i.e., the collateral exchange value) for a resource exchange entry corresponding to the resource exchange between the secondary client 118 and the medical facility. The element 504-9(b) further includes data field 702-1 that renders information of medical claim(s) in the resource exchange entry responsible for the unstable resource exchange to the secondary client 118.

FIGS. 7(C) and 7(D) illustrate example embodiments of the application interfaces (i.e., GUI 700-3 and GUI 700-4) generated by the system 100 when the unstable resource exchange is determined by the system 100. Particularly, the GUI 700-3 presents an element 504-9(c) that presents an updated resource exchange entry corresponding to the resource exchange between the secondary client 118 and the medical facility. The element 504-9(c) includes a data field 702-3 that presents information of a new medical claim replacing ‘high risk’ claim of the resource exchange entry to the secondary client 118. Moreover, the element 504-9(c) presents data corresponding to the updated resource exchange entry (such as updated collateral value) to the user (i.e., secondary client 118). The GUI 700-4 presents an element 504-9(d) that depicts another updated resource exchange entry corresponding to the resource exchange between the secondary client 118 and the medical facility. The element 504-9(d) includes a data field 702-4 that presents information of a new set of medical claims replacing all the medical claims of the resource exchange entry to the secondary client 118. Moreover, the element 504-9(d) presents data corresponding to the updated resource exchange entry (such as updated collateral value) to the user (i.e., secondary client 118).

FIGS. 8(A)-8(I) illustrate GUIs 800-1 through 800-9 generated by the system 100 and presented through the user device 400 corresponding to onboarding and managing accounts of different entities (i.e., the medical facility, the primary clients 116, and the secondary clients 118) of the system 100, in accordance with an exemplary aspect of the present disclosure. The GUI 800-1 is rendered by the application interface when the user selects the dashboard option from the element 502-1. In such a scenario, the element 502-2 may indicate a settings option 802-1. In an exemplary scenario, when the user selects (or clicks on) the settings option 802-1 from the element 502-2, the system 100 may generate an element 504-10 on the GUI 800-1. The element 504-10 includes options to select and add details corresponding to various entities of the system 100 (e.g., the medical facility, the primary clients 116, and the secondary clients 118). Based on the selection(s) of the entity from the options in the element 504-10, the application renders to another application interface.

Specifically, when the user selects to add details of the medical facility, the application renders to the application interface presented through the GUI 800-2. The GUI 800-2 includes an element 504-11 comprising several selectable options (e.g., data fields) that enables the user to provide details of the medical facility to the system 100. The element 504-11 further includes an option to add a medical facility that may be submitted upon submitting input(s) for required data fields of the element 504-11. When the user provides the input(s) for the required data fields of the element 504-11 and submits the addition of the medical facility, the application may render to another application interface presented through GUI 800-3. The GUI 800-3 includes an element 504-12 that renders details of the medical facility added to the system 100. The element 504-12 further includes an option to search medical facilities added to the system 100. Furthermore, the element 504-12 may also include an option to add details of a new medical facility to the system 100, which when clicked by the user renders the application to the application interface presented through GUI 800-2.

In an exemplary scenario, when the user selects to add details of a secondary client 118 (presented as financial partner) to the system, the application renders to GUI 800-4. The GUI 800-4 may include an element 504-14 that includes a number of selectable options to enable the user for providing details of the secondary client 118 to be added to the system 100. The element 504-14 further includes an option to add a secondary client 118 to the system that may be submitted upon submitting input(s) for required data fields of the element 504-14. When the user provides the input(s) for the required data fields of the element 504-14 and submits the addition of the new secondary client 118, the application may render to another application interface presented through GUI 800-5. The GUI 800-5 includes an element 504-15 that renders details of the new secondary client added to the system 100. The element 504-15 further includes an option to search secondary client 118 added to the system 100. Furthermore, the element 504-15 may also include an option to add details of a new secondary client 118 to the system 100, which when clicked by the user renders the application to the application interface presented through GUI 800-4.

In an exemplary scenario, when the user selects to add details of a primary client 116 (presented as financial partner) to the system 100, the application renders to GUI 800-6. The GUI 800-6 may include an element 504-16 that includes a number of selectable options to enable the user for providing details of the primary client 116 to be added to the system 100. The element 504-16 further includes an option to add the primary client 116 to the system that may be submitted upon submitting input(s) for required data fields of the element 504-16. Once the details of the newly added primary client 116 are submitted, the system 100 may generate an account for the newly added primary client 116 to access the service(s) of the system 100.

In an exemplary scenario, when the user selects to add details of an end user 114 (presented as financial partner) to the system 100, the application renders to GUI 800-7. The GUI 800-7 may include an element 504-17 that includes a number of selectable options to enable the user for providing details of the end user 114 to be added to the system 100. The element 504-17 further includes an option to add the end user 114 to the system that may be submitted upon submitting input(s) for required data fields of the element 504-17. Once the details of the newly added end user 114 are submitted, the system 100 may generate an account for the newly added end user 114 to access the service(s) of the system 100.

In an exemplary scenario, when the user selects to add department details of medical facility associated with a medical claim and/or details of the preferred primary client 116 for the medical claim, the application renders to GUI 800-8. The GUI 800-8 may include an element 504-18 that includes a number of selectable options to enable the user for providing details of the department for the medical claim and select a preferred primary client 116. The element 504-18 further includes an option to add the department to the system that may be submitted upon submitting input(s) for required data fields of the element 504-18.

In an exemplary scenario, when the user selects to edit details medical facility to the system 100, the application renders to GUI 800-9. The GUI 800-9 may include an element 504-19 that includes a number of selectable options to enable the user for editing (or updating) details of the selected medical facility. The element 504-19 further includes an option to update the details of the medical facility into the server memory 122.

As will be apparent to a person of ordinary skill in the art, the GUIs presented by FIG. 5(A) through FIG. 8(I) are for illustration of some of the functions performed by the system 100, according to some exemplary aspects of the present disclosure. It must be noted that the GUIs (as presented) does not signify a specific form of data presentation or providing information to or by the system 100 that may limit the scope of the present disclosure. Rather, the system 100 may generate any type of GUIs as may be suitable to render the various operations of the system 100 presented above.

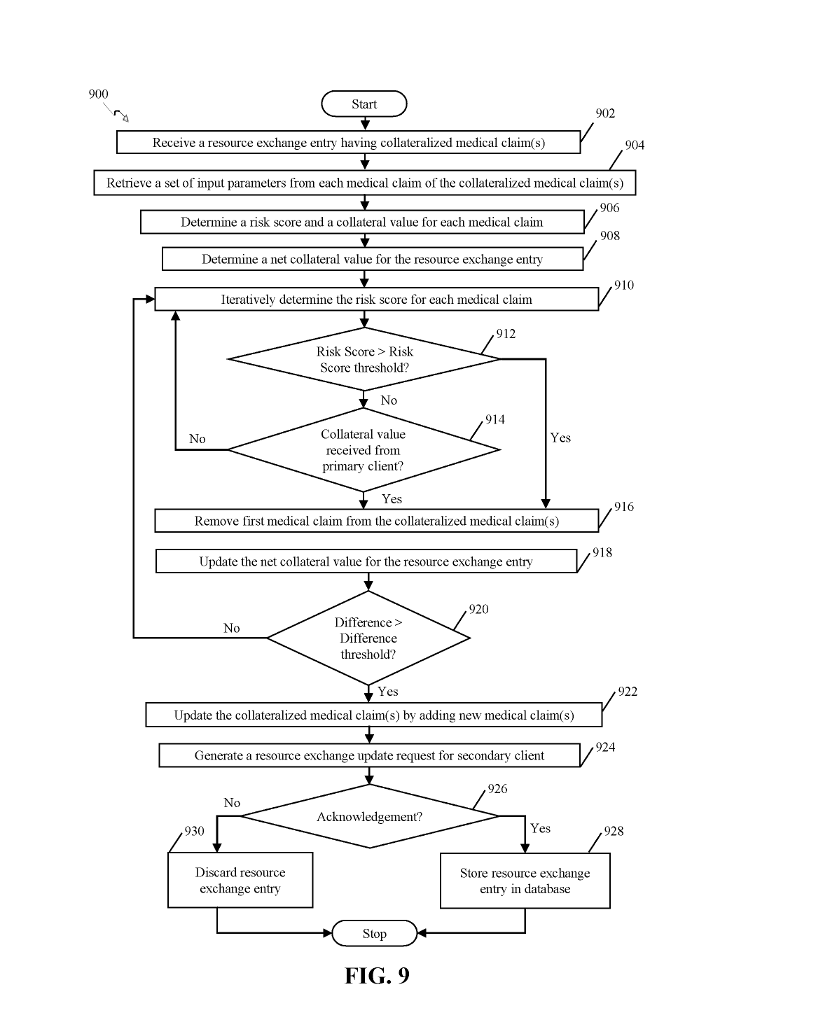

FIG. 9 is a flow chart that depicts a method for managing resources of the secondary client 118, in accordance with an exemplary aspect of the present disclosure.

At block 902, the data processing server 108 may retrieve the resource exchange entry corresponding to the exchange of the resources of the secondary client 118 for collateralized medical claim(s) associated with the medical facility from the server memory 112.

At block 904, the data processing server 108 may retrieve the set of input parameters from each medical claim of the collateralized medical claim(s). The set of input parameters for each medical claim comprises the claim age value of the medical claim and the DTP value for the medical claim. In some aspects of the present disclosure, the set of input parameters for the medical claim may further include the claim identifier, the claim amount, and the claim date for the medical claim.

At block 906, the data processing server 108 may determine the risk score and the collateral value for each medical claim through the first Machine Learning (ML) model 110 trained using the historical claim data. The risk score and the collateral value dynamically change based on a variation in the claim age value of the medical claim, the DTP value for the medical claim, and any new claim settlement entry in the historical claim data.

At block 908, the data processing server 108 may determine the net collateral value of the medical claims by summing the collateral value of each medical claim in the resource exchange entry.

At block 910, the data processing server 108 may iteratively determine the risk score for each medical claim in the resource exchange entry. The iteration may be continuous, periodic, or dynamic.

At block 912, the data processing server 108 may determine whether the risk score of any medical claim from the collateralized medical claims exceeds the risk score threshold value. When the risk score of the first medical claim from the collateralized medical claims exceeds the risk score threshold value, the method 900 proceeds to block 916. Else when the risk score of none of the collateralized medical claims exceeds the risk score threshold value, the method 900 proceeds to block 914.

At block 914, the data processing server 108 may determine whether the collateral value for any medical claim from the collateralized medical claims is received by the medical facility from the primary client 116. When the data processing server 108 determines that the collateral value for the second medical claim is received by the medical facility from the primary client 116, the method 900 proceeds to block 916. Else when the collateral value for none of the collateralized medical claims is received by the medical facility from the primary client 116, the method 900 falls back to the block 910.

At block 916, the data processing server 108 may remove high-risk medical claim from the resource exchange entry. For example, when the data processing server 108 determines that the risk score of the first medical claim exceeds the risk score threshold value, the first medical claim is removed from the resource exchange entry. When, the data processing server 108 determines that the collateral value for the second medical claim is received by the medical facility from the primary client 116, the second medical claim is removed. A combination of the abovementioned examples is also possible, where both the first medical claim and the second medical claim are removed, when meeting the respective requirements.

At block 918, the data processing server 108 may update the net collateral value of the collateralized medical claims based on the removal of the high-risk medical claim from the resource exchange entry.

At block 920, the data processing server 108 may determine, whether the difference between the net collateral value and the collateral exchange value is less than the difference threshold value. The collateral exchange value is determined at the time instance corresponding to the generation of the resource exchange entry, and is lower than the net collateral value by the margin exposure value at the time instance. When the difference between the net collateral value and the collateral exchange value is less than the difference threshold value, the method 900 proceeds to block 922. Else when the difference between the net collateral value and the collateral exchange value is greater than or equal to the difference threshold value, the method 900 falls back to the block 910.

At block 922, the data processing server 108 may determine new medical claim(s) from a number of collateralized medical claims (other than those included in the resource exchange entry) associated with the medical facility using the second ML model 110 and update the resource exchange entry using the new medical claim(s). In some aspects of the present disclosure, the data processing server 108 may replace the high-risk medical claims with the new medical claim(s). In some other aspects of the present disclosure, the data processing server 108 may replace all the medical claims with a new set of medical claims determined using the second ML model 110. The new medical claim(s) may compensate for the change in the net collateral value due to removal of the first medical claim and/or the second medical claim.

At block 924, the data processing server 108 may generate the resource exchange update request for the secondary client 118 using the updated resource exchange entry. The resource exchange update request may include information related to the update(s) in the data exchange entry. The data processing server 108 may further send the resource exchange update request to the secondary client 118 for approval of the updated resource exchange.

At block 926, the data processing server 108 may determine whether the resource exchange acknowledgement is received from the secondary client device 106 associated with the secondary client 118 in response to the resource exchange update request. When the resource exchange acknowledgement is received from the secondary client device 106 within a predefined time, the method 900 proceeds to block 928. Else when the resource exchange acknowledgement is received from the secondary client device 106 within the predefined time, the method 900 proceeds to block 930.

At block 928, the data processing server 108 may store the updated resource exchange entry into the server memory 122. The updates resource exchange entry may further be utilized by the data processing server 108 for managing resources exchanged with the medical facility.

At block 930, the data processing server 108 may discard the resource exchange entry and may generate a transaction cancel notification for the medical facility and the secondary client 118.

Now, referring to the technical abilities and advantageous effect of the present disclosure, the disclosure presents a platform that allows access to alternate financing by leveraging medical claims (i.e., receivables) as collateral. Given the challenges (quality, time delays upwards of 45 days, risk of payment, etc.) with medical claims processing, the platform takes a unique approach to validating the claims, identifying the risk associated with the claims & providing insights for both medical facilities and the clients to make educated decision on using the medical claim as collateral. Moreover, the platform is backed by an “Asset backed commercial paper” program from the clients that allows for them to provide funding to the customers for their operational needs, without having the customer go through regular channels (e.g., line of credit, revolver credit etc.) from their banking partners. In addition, the platform also assures medical facilities to keep track of their receivables and solve their monitory problems. Particularly, the platform manages resource exchange between the medical facility and the finance providers and alerts them about any high-risk situation in advance. Moreover, the platform enables amendment of resources exchanged between the medical facility and the financial partners for high-risk conditions to keep the trade stable, transparent, and reliable.

Those skilled in the art will appreciate that the methodology described herein in the present disclosure may be carried out in other specific ways than those set forth herein in the above disclosed embodiments without departing from essential characteristics and features of the present invention. The above-described embodiments are therefore to be construed in all aspects as illustrative and not restrictive.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Any combination of the above features and functionalities may be used in accordance with one or more embodiments.

In the present disclosure, each of the embodiments has been described with reference to numerous specific details which may vary from embodiment to embodiment. The foregoing description of the specific embodiments disclosed herein may reveal the general nature of the embodiments herein that others may, by applying current knowledge, readily modify and/or adapt for various applications such specific embodiments without departing from the generic concept, and, therefore, such adaptations and modifications are intended to be comprehended within the meaning of the disclosed embodiments. It is to be understood that the phraseology or terminology employed herein is for the purpose of description and is not limited in scope.

What is claimed is:

1. A method for managing resources associated with a secondary client, the method comprising:
retrieving, from a database, a resource exchange entry corresponding to exchange of the resources for one or more collateralized medical claims associated with a medical facility;
retrieving a set of input parameters from each medical claim of the one or more collateralized medical claims, wherein the set of input parameters for each medical claim comprises a claim age value of the medical claim and a days to pay (DTP) value for the medical claim;
determining, through a first Machine Learning (ML) model trained using historical claim data, a risk score and a collateral value for each medical claim of the one or more collateralized medical claims, wherein the risk score and the collateral value dynamically change based on at least one of a variation in the claim age value of the medical claim, the DTP value for the medical claim, and a new claim settlement entry in the historical claim data;
determining a net collateral value of the one or more medical claims by summing the collateral value of each medical claim;
determining whether the risk score of a first medical claim of the one or more collateralized medical claims exceeds a risk score threshold value;
removing the first medical claim from the one or more medical claims in response to the determination that the risk score of the first medical claim exceeds the risk score threshold value; and
updating the net collateral value of the one or more collateralized medical claims based on the removal of the first medical claim from the one or more collateralized medical claims.

2. The method of claim 1, further comprising:
determining whether the collateral value for a second medical claim from the one or more collateralized medical claims is received by the medical facility from a primary client;
removing the second medical claim from the one or more medical claims in response to the determination that the collateral value for the second medical claim is received by the medical facility from the primary client; and
updating the net collateral value of the one or more collateralized medical claims based on the removal of the second medical claim from the one or more collateralized medical claims.

3. The method of claim 2, further comprising:
determining, whether a difference between the net collateral value and a collateral exchange value is less than a difference threshold value, wherein the collateral exchange value is determined at a time instance corresponding to a generation of the resource exchange entry and is lower than the net collateral value by a margin exposure value at the time instance;
determining, in response to the determination that the difference between the net collateral value and the collateral exchange value is less than the difference threshold value, at least one new medical claim from a plurality of collateralized medical claims associated with the medical facility using a second ML model; and
updating the resource exchange entry by adding the at least one new medical claim to the one or more collateralized medical claims, wherein the at least one new medical claim compensates for a change in the net collateral value.

4. The method of claim 3, further comprising:
generating a resource exchange update request for the secondary client using the updated resource exchange entry;
determining whether a resource exchange acknowledgement is received from the secondary client in response to the resource exchange update request; and
storing, in response to a determination that the resource exchange acknowledgement is received from the secondary client, the updated resource exchange entry into the database.

5. The method of claim 1, further comprises determining a risk category from a
plurality of risk categories for each medical claim of the one or more collateralized medical claims based on the risk score associated with the medical claim.

6. The method of claim 1, wherein:
the set of input parameters comprises a claim identifier, a claim amount, and a claim date for the medical claim; and
the historical claim data comprises information of a plurality of medical claim settlements.

7. The method of claim 6, wherein the claim age value corresponds to a duration
between a present temporal value and the claim date, and the DTP value corresponds to a duration between the present temporal value and an expected claim settlement date.

8. The method of claim 1, wherein the new claim settlement entry in the historical
claim data corresponds to a change in at least one of a ranking of the primary client, a rating of the primary client, and a status of the primary client.

9. A system to manage resources associated with a secondary client, the system comprising:
a database; and
data processing circuitry communicatively coupled with the database, wherein the data processing circuitry is configured to:
retrieve, from the database, a resource exchange entry corresponding to exchange of the resources for one or more collateralized medical claims associated with a medical facility;
retrieve a set of input parameters from each medical claim of the one or more collateralized medical claims, wherein the set of input parameters for each medical claim comprises a claim age value of the medical claim and a days to pay (DTP) value for the medical claim;
determine, through a first Machine Learning (ML) model trained using a historical claim data, a risk score and a collateral value for each medical claim of the one or more collateralized medical claims, wherein the risk score and the collateral value dynamically change based on at least one of a variation in the claim age value of the medical claim, the DTP value for the medical claim, and a new claim settlement entry in the historical claim data;
determine a net collateral value of the one or more medical claims by summing the collateral value of each medical claim;
determine whether the risk score of a first medical claim of the one or more collateralized medical claims exceeds a risk score threshold value;
remove the first medical claim from the one or more medical claims in response to the determination that the risk score of the first medical claim exceeds the risk score threshold value; and
update the net collateral value of the one or more collateralized medical claims based on the removal of the first medical claim from the one or more collateralized medical claims.

10. The system of claim 9, wherein the data processing circuitry is further configured to:
determine whether the collateral value for a second medical claim from the one or more collateralized medical claims is received by the medical facility from a primary client;
remove the second medical claim from the one or more medical claims in response to the determination that the collateral value for the second medical claim is received by the medical facility from the primary client; and
update the net collateral value of the one or more collateralized medical claims based on the removal of the second medical claim from the one or more collateralized medical claims.

11. The system of claim 10, wherein the data processing circuitry is further configured to:
determine, whether a difference between the net collateral value and a collateral exchange value is less than a difference threshold value, wherein the collateral exchange value is determined at a time instance corresponding to a generation of the resource exchange entry and is lower than the net collateral value by a margin exposure value at the time instance;
determine, in response to the determination that the difference between the net collateral value and the collateral exchange value is less than the difference threshold value, at least one new medical claim from a plurality of collateralized medical claims associated with the medical facility using a second ML model; and
update the resource exchange entry by adding the at least one new medical claim to the one or more collateralized medical claims, wherein the at least one new medical claim compensates for a change in the net collateral value.

12. The system of claim 11 wherein the data processing circuitry is further configured to:
generate a resource exchange update request for the secondary client using the updated resource exchange entry;
determine whether a resource exchange acknowledgement is received from the secondary client in response to the resource exchange update request; and
store, in response to a determination that the resource exchange acknowledgement is received from the secondary client, the updated resource exchange entry into the database.

13. The system of claim 9, wherein the data processing circuitry is further configured to determine a risk category from a plurality of risk categories for each medical claim of the one or more collateralized medical claims based on the risk score associated with the medical claim.

14. The system of claim 9, wherein:
the set of input parameters comprises a claim identifier, a claim amount, and a claim date for the medical claim; and
the historical claim data comprises information of a plurality of medical claim settlements.

15. The system of claim 14, wherein the claim age value corresponds to a duration
between a present temporal value and the claim date, and the DTP value corresponds to a duration between the present temporal value and an expected claim settlement date.

16. The system of claim 9, wherein the new claim settlement entry in the historical
claim data corresponds to a change in at least one of a ranking of the primary client, a rating of the primary client, and a status of the primary client.

17. A computer-program product for managing resources associated with a
secondary client, the computer program product comprising computer-executable instructions that are stored on a non-transitory computer-readable medium and that, when executed by data processing circuitry performs operations comprising:
retrieving, from a database, a resource exchange entry corresponding to exchange of the resources for one or more collateralized medical claims associated with a medical facility;
retrieving a set of input parameters from each medical claim of the one or more collateralized medical claims, wherein the set of input parameters for each medical claim comprises a claim age value of the medical claim and a days to pay (DTP) value for the medical claim;
determining, through a first Machine Learning (ML) model trained using a historical claim data, a risk score and a collateral value for each medical claim of the one or more collateralized medical claims, wherein the risk score and the collateral value dynamically change based on at least one of a variation in the claim age value of the medical claim, the DTP value for the medical claim, and a new claim settlement entry in the historical claim data;
determining a net collateral value of the one or more medical claims by summing the collateral value of each medical claim;
determining whether the risk score of a first medical claim of the one or more collateralized medical claims exceeds a risk score threshold value;
removing the first medical claim from the one or more medical claims in response to the determination that the risk score of the first medical claim exceeds the risk score threshold value; and
updating the net collateral value of the one or more collateralized medical claims based on the removal of the first medical claim from the one or more collateralized medical claims.

18. The computer-program product of claim 17, wherein the operations further comprising:
determining whether the collateral value for a second medical claim from the one or more collateralized medical claims is received by the medical facility from a primary client;
removing the second medical claim from the one or more medical claims in response to the determination that the collateral value for the second medical claim is received by the medical facility from the primary client; and
updating the net collateral value of the one or more collateralized medical claims based on the removal of the second medical claim from the one or more collateralized medical claims.

19. The computer-program product of claim 18, wherein the operations further comprising:
determining, whether a difference between the net collateral value and a collateral exchange value is less than a difference threshold value, wherein the collateral exchange value is determined at a time instance corresponding to a generation of the resource exchange entry and is lower than the net collateral value by a margin exposure value at the time instance;
determining, in response to the determination that the difference between the net collateral value and the collateral exchange value is less than the difference threshold value, at least one new medical claim from a plurality of collateralized medical claims associated with the medical facility using a second ML model; and
updating the resource exchange entry by adding the at least one new medical claim to the one or more collateralized medical claims, wherein the at least one new medical claim compensates for a change in the net collateral value.

20. The computer-program product of claim 19, wherein the operations further comprising:
generating a resource exchange update request for the secondary client using the updated resource exchange entry;
determining whether a resource exchange acknowledgement is received from the secondary client in response to the resource exchange update request; and
storing, in response to a determination that the resource exchange acknowledgement is received from the secondary client, the updated resource exchange entry into the database.

21. The computer-program product of claim 17, wherein the operations further
comprise determining a risk category from a plurality of risk categories for each medical claim of the one or more collateralized medical claims based on the risk score associated with the medical claim.

22. The computer-program product of claim 17, wherein:
the set of input parameters comprises a claim identifier, a claim amount, and a claim date for the medical claim; and
the historical claim data comprises information of a plurality of medical claim settlements.

23. The computer-program product of claim 22, wherein the claim age value
corresponds to a duration between a present temporal value and the claim date, and the DTP value corresponds to a duration between the present temporal value and an expected claim settlement date.

24. The computer-program product of claim 17, wherein the new claim settlement
entry in the historical claim data corresponds to a change in at least one of a ranking of the primary client, a rating of the primary client, and a status of the primary client.
